(19) United States
(12) Patent Application Publication
(10) Pub. No.: US 2006/0184381 A1
(43) Pub. Date: Aug. 17, 2006

(54) Computer-implemented method and system for matching a consumer to a home service provider

(75) Inventors: Rodney S. Rice, Golden, CO (US); Michael J. Beaudoin, Golden, CO (US); James Andrew Zurcher, Golden, CO (US); Ryan J. Sullivan, Golden, CO (US)

Correspondence Address: KING & SPALDING LLP, 1180 PEACHTREE STREET, ATLANTA, GA, 30309, US

(73) Assignee: ServiceMagic, Inc., Golden, CO (US)

(21) Appl. No.: 11/342,262

(22) Filed: Jan. 27, 2006

Related U.S. Application Data
(60) Provisional application No. 60/647,640, filed on Jan. 27, 2005.
(60) Provisional application No. 60/689,648, filed on Jun. 10, 2005.

(51) Int. Cl. G06Q 99/00; G07G 1/00; G06F 17/30

(52) U.S. Cl. 705/1; 705/10

(57) ABSTRACT

A method and system for matching ready-to-act consumers and pre-qualified service providers are described. Consumer-to-Business commerce transactions can be facilitated by pre-qualifying both consumers and service providers and matching a consumer who selects a single, pre-qualified service provider. For example, according to one exemplary embodiment of the invention, using information provided by the consumer, such as the consumer's address, type of work requested, etc., a matching system can determine whether a single, pre-qualified home service provider chosen by the consumer matches or meets the service need of the consumer and other criteria of the matching system. If the matching system determines that the consumer and the consumer's single, selected home service provider are not a match, then the consumer may permit his or her service request to be matched with the consumer lead criteria of one or more un-known or not previously selected service providers relative to the consumer.

### PRIORITY AND RELATED APPLICATIONS

The present application claims priority to provisional patent application entitled, “Exact Match,” filed on Jan. 27, 2005 and assigned U.S. Application Ser. No. 60/647,640 and to provisional application entitled, “Exact Match Architecture,” filed on Jun. 10, 2005 and assigned U.S. Application Ser. No. 60/689,648, the entire contents of both provisional patent applications are hereby incorporated by reference in their entirety. This application is also related to commonly owned and co-pending non-provisional patent application entitled, “Facilitating Commerce Among Consumers and Service Providers by Matching Ready-to-Act Consumers and Pre-Qualified Service Providers,” filed on May 19, 2000 and assigned U.S. patent application Ser. No. 09/574,909.

### FIELD OF THE INVENTION

The invention relates generally to the field of Consumer-to-Business commerce. More particularly, the invention relates to a method and apparatus for facilitating commerce among consumers and home services service providers.

### BACKGROUND OF THE INVENTION

The local service economy is dominated by inefficiency. Many factors contribute to this inefficiency. For example, consumers have difficulties identifying appropriate home service providers to meet their needs; and consumers cannot readily distinguish relative home service provider quality. Home service providers, on the other hand, can have difficulty promoting themselves in such a way that they will receive new consumer leads for home service projects that meet their work preferences.

In light of the foregoing, what is needed is a system to enable a consumer to identify an appropriate service provider, to determine if the consumer's needs can be met by the pre-qualified service provider, to connect the two parties together or, if it has been determined that the service provider is unable to meet the consumer's need, to facilitate a match to other pre-qualified service providers who can meet their need.

### SUMMARY OF THE INVENTION

A method and system can distribute consumer leads and present pre-qualified home service providers to ready-to-act consumers, and then match the two parties together via a one-to-one matching platform. Initially, a database of pre-screened home service providers is established, wherein certain screening criteria are used and service provider profile information is gathered. This profile information is developed into a webpage format, optimized to be indexed by search engines so that the webpage will appear in search engine search results based on queries from consumers. Additionally, the profiles of these service providers are made available to consumers by distributing the profile to other web sites on the Internet who display service businesses, such as directories or IYP (Internet Yellow Pages). Service provider profiles are not limited in their presentation on web sites. The directory of Exact Match service providers can also be distributed via other electronic vehicles, such as a personal digital assistant (PDA) and telephone directories, or non-electronic vehicles, such as a printed directory, or any other vehicle that could be used to convey the profile information.

After reviewing the web page displaying a service provider's profile information, the consumer may choose to contact a single service provider by telephone or on-line. If and when a consumer chooses to contact a single service provider, a description of the consumer's service needs and contact information can be obtained from the consumer, either via telephone or on-line, by a matching system or matching system operator on behalf of the service provider. Subsequently, the consumer needs will be reviewed by the matching system and compared against the predetermined criteria for consumer leads provided by the single, service provider that was selected or chosen by the consumer.

If the consumer's needs match the consumer lead criteria provided by the single service provider who was selected by the consumer, then the system will facilitate a connection between the two parties. That is, during the primary matching process, the system verifies that the single service provider selected by the consumer is a good or “exact” match meaning that the selected single service provider can fulfill the consumer's service request and other criteria discussed below that is reviewed by the inventive matching system.

If the system determines that the service provider is a good or “exact match,” the system can connect the two parties. For example, the system may connected the consumer to the selected, single service provider by telephone. Additionally, the connection may occur by presenting the consumer's needs and contact information to the service provider by way of a set of heterogeneous communication devices depending upon preferences supplied by the service provider.

If the system determines that consumer's needs or service request do not match the criteria provided to the system by the chosen service provider, the consumer is presented with an option to initiate a secondary matching process (relative to the first or primary matching process) in order for the consumer to be matched with one or more service providers who were not selected by the consumer but whose profiles may match a consumer's specified needs/consumer service request. In this secondary matching process, the consumer's service request becomes the focus of the matching process where the service request is compared to the consumer lead criteria of multiple service providers who have not been selected by the consumer. This secondary matching process is different from the primary matching process because the consumer lead criteria of a selected single service provider is no longer compared to the consumer's service request. Instead, the consumer lead criteria of multiple service providers who have not been selected by the consumer are compared to the consumer's service request. This secondary process of matching un-selected or unknown service providers (relative to the consumer but are in the database of the inventive matching system) to a consumer request is referred to as the market match secondary process.

While the market match secondary process is different relative to the primary matching process because of the parties being compared, the market match secondary process does also share some similarities with the primary matching process. These similarities can include exemplary consumer lead criteria provided by service providers that is used by the matching system to determine if a service provider matches a consumer. Both the primary “exact match” process and the secondary “market match” process use the following consumer lead criteria: whether a service provider has an “approved status” relative to the type of service requested; whether a service provider is currently “accepting leads”; whether the service provider has a skill set that matches the type of service requested; and whether the geographic location of the service provider matches the geographic location of the service requested. This exemplary consumer lead criteria is more fully described below.

According to the market match secondary process in which multiple service providers may be contacted to fulfill a service request of a consumer, the consumer needs or consumer service request may be presented, for example, by way of a set of heterogeneous communication devices depending upon preferences supplied by the multiple service providers. A pre-determined number of service providers may accept the lead, either automatically based on predetermined criteria, or by manual review of the service need, within a designated time period. Serially, at the time of each acceptance, the profiles of the pre-qualified service providers are presented to the consumer. At this time, the consumer contact information is also distributed to the accepting service providers. The consumer may then select from the pre-qualified service providers based upon one or more objective and/or subjective factors associated with the pre-qualified service providers presented to the consumer. Such objective and subjective information, for example ratings & review information, may be collected by the system and subsequently presented to consumers.

According to another aspect of the invention, the system may automatically initiate follow-up communications with the consumers and service providers to request information regarding confirmation of service transactions, such information may form the basis for the business model and/or the subjective information provided to consumers.

Other features of the present invention will be apparent from the accompanying drawings and from the detailed description listed below.

### BRIEF DESCRIPTION OF THE DRAWINGS

The invention, together with its advantages, may be best understood from the following detailed description taken in conjunction with the accompanying drawings of which:

FIG. 1 is functional block diagram that illustrates an exemplary computer system upon which one exemplary embodiment of the invention may be implemented.

FIG. 2 is a functional block diagram that illustrates a high level overview of the technology platform according to one exemplary embodiment of the invention.

FIG. 3 is a logic flow diagram illustrating an exemplary service provider enrollment process in which a service provider can be enrolled in a database as an “approved” provider according to one exemplary embodiment of the invention.

FIG. 4 is a logic flow diagram that illustrates an overview of exemplary primary process of matching a consumer service request with a service provider when a consumer selects a provider based on an advertisement as well as a secondary matching process of matching a consumer with a plurality of service providers based on the type of home service requested by the consumer according to one exemplary embodiment of the invention.

FIG. 5 is a functional block diagram that illustrates different methods in which profiles of service providers may be distributed over a computer network for display and selection by consumers according to one exemplary embodiment of the invention.

FIG. 6A is a first logic flow diagram that illustrates an exemplary process in which a consumer can use a telephone to access the primary matching system that verifies a match of a single service provider selected by the consumer according to one exemplary embodiment of the invention.

FIG. 6B is a second logic flow diagram that continues from the first flow diagram of FIG. 6A and that illustrates additional exemplary steps that describe how a consumer may be linked to the selected single service provider through a telephone according to one exemplary embodiment of the invention.

FIG. 7 is a first logic flow diagram that illustrates an exemplary process in which a consumer can use a computer to access the primary matching system that verifies a match of a single service provider selected by the consumer according to one exemplary embodiment of the invention.

FIG. 8 is a logic flow diagram that illustrates an exemplary process of a secondary market match request, in which a consumer may engage to identify other service providers once the system determines that the single service provider originally chosen by the consumer does not meet the criteria specified by that service provider.

FIG. 9A is an exemplary computer screen display illustrating a service provider profile according to one exemplary embodiment of the invention.

FIG. 9B is an exemplary computer screen display illustrating a service provider profile with a ratings and review user interface according to an exemplary embodiment of the invention.

FIG. 10A is an exemplary computer screen display illustrating a service provider profile distribution as an organic search result according to an exemplary embodiment of the invention.

FIG. 10B is an exemplary computer screen display illustrating a service provider profile distribution as a Internet Yellow Pages (IYP) listing according to an exemplary embodiment of the invention.

FIG. 10C is an exemplary computer screen display illustrating a service provider profile distribution that is generated by the inventive matching system according to an exemplary embodiment of the invention.

FIG. 11A is an exemplary computer screen display illustrating a customer service representative user interface according to an exemplary embodiment of the invention.

FIG. 11B is another exemplary computer screen display illustrating a customer service representative user interface according to an exemplary embodiment of the invention.

FIG. 11C is another exemplary computer screen display illustrating a customer service representative user interface according to an exemplary embodiment of the invention.

FIG. 11D is another exemplary computer screen display illustrating a customer service representative user interface according to an exemplary embodiment of the invention.

FIG. 11E is another exemplary computer screen display illustrating a customer service representative user interface according to an exemplary embodiment of the invention.

FIG. 11F is another exemplary computer screen display illustrating a customer service representative user interface according to an exemplary embodiment of the invention.

FIG. 11G is another exemplary computer screen display illustrating an e-mail notification sent to a service provider according to an exemplary embodiment of the invention.

FIG. 11H is another exemplary computer screen display illustrating an e-mail notification sent to a consumer according to an exemplary embodiment of the invention.

FIG. 11I is another exemplary computer screen display illustrating an e-mail notification sent to a consumer that appears to originate from the service provider according to an exemplary embodiment of the invention.

FIG. 11J is another exemplary computer screen display illustrating a customer service representative user interface according to an exemplary embodiment of the invention.

FIG. 11K is another exemplary computer screen display illustrating a customer service representative user interface according to an exemplary embodiment of the invention.

FIG. 11L is another exemplary computer screen display illustrating a customer service representative user interface according to an exemplary embodiment of the invention.

FIG. 11M is another exemplary computer screen display illustrating a customer service representative user interface according to an exemplary embodiment of the invention.

FIG. 12A is another exemplary computer screen display illustrating an on-line service request form according to an exemplary embodiment of the invention.

FIG. 12B is another exemplary computer screen display illustrating an on-line service request form according to an exemplary embodiment of the invention.

FIG. 12C is another exemplary computer screen display illustrating an on-line service request form according to an exemplary embodiment of the invention.

FIG. 12D is another exemplary computer screen display illustrating an on-line service request form according to an exemplary embodiment of the invention.

FIG. 12E is another exemplary computer screen display illustrating a service request submission confirmation according to an exemplary embodiment of the invention.

FIG. 12F is another exemplary computer screen display illustrating a e-mail notification of an exact match lead request sent to a home service provider according to an exemplary embodiment of the invention.

FIG. 12G is another exemplary computer screen display illustrating a e-mail notification of an exact match confirmation of the submission of a consumer's service request that is sent to a consumer according to an exemplary embodiment of the invention.

FIG. 12H is another exemplary computer screen display illustrating a e-mail notification of an exact match lead request sent to a consumer according to an exemplary embodiment of the invention.

FIG. 12I is another exemplary computer screen display illustrating an on-line service request form according to an exemplary embodiment of the invention.

FIG. 13A is another exemplary computer screen display illustrating an e-mail notification of a market match request sent to a consumer according to an exemplary embodiment of the invention.

FIG. 13B is another exemplary computer screen display illustrating an e-mail notification of a market match sent to a home service provider according to an exemplary embodiment of the invention.

FIG. 13C is another exemplary computer screen display illustrating an e-mail notification of a service provider profile match from a market match that is sent to a consumer according to an exemplary embodiment of the invention.

FIG. 13D is another exemplary computer screen display illustrating a web page listing a service provider profile match from a market match that can be viewed by a consumer according to an exemplary embodiment of the invention.

FIG. 13E is another exemplary computer screen display illustrating a web page listing a service provider profile match from an exact match primary process that can be viewed by a consumer according to an exemplary embodiment of the invention.

FIG. 13F is another exemplary computer screen display illustrating a web page listing a service provider profile match from a market match secondary process that can be viewed by a consumer according to an exemplary embodiment of the invention.

FIG. 13G is another exemplary computer screen display illustrating an e-mail message that can be created from a communications platform by a consumer according to an exemplary embodiment of the invention.

FIG. 13H is another exemplary computer screen display illustrating an e-mail notification of a market matched service providers sent to a consumer according to an exemplary embodiment of the invention.

FIG. 13I is another exemplary computer screen display illustrating an e-mail notification of a request for ratings and reviews of service providers sent to a consumer according to an exemplary embodiment of the invention.

FIG. 13J is another exemplary computer screen display illustrating a web page listing service providers who are not in the matching system database that can be viewed by a consumer according to an exemplary embodiment of the invention.

FIG. 13K is another exemplary computer screen display illustrating an e-mail notification of service providers who are not in the database of the matching system according to an exemplary embodiment of the invention.

FIG. 13L is another exemplary computer screen display illustrating an e-mail notification that no market match service providers have responded to the market match request according to an exemplary embodiment of the invention.

FIG. 13M is another exemplary computer screen display illustrating a web page listing service providers who were market matched to the consumer service request but did not accept the request according to an exemplary embodiment of the invention.

FIG. 13N is another exemplary computer screen display illustrating an e-mail notification that can be sent to Lead Select enrolled service providers according to an exemplary embodiment of the invention.

### DETAILED DESCRIPTION OF EXEMPLARY EMBODIMENTS OF THE INVENTION

A method and system for matching ready-to-act consumers and pre-qualified service providers are described. Broadly stated, according to the present invention, Consumer-to-Business commerce transactions can be facilitated by pre-qualifying both consumers and service providers and matching a consumer who selects a single, pre-qualified service provider. For example, according to one exemplary embodiment of the invention, using information provided by the consumer, such as the consumer's address, type of work requested, etc., a matching system can determine whether a single, pre-qualified home service provider chosen by the consumer matches or meets the service need of the consumer and other criteria reviewed by the matching system.

Home service providers can offer services that include, but are not limited to, roofing, HVAC services, plumbing, electrical work, exterior home repair and remodel, interior home repair and remodel, general carpentry, bathroom and kitchen work, painting, landscaping, interior decorating, home inspection, appraisal services, home security, and other like home services.

If the matching system determines that the consumer and the consumer's single, selected home service provider are not a match, then the consumer may permit his or her service request to be matched with the consumer lead criteria of one or more un-known or not previously selected service providers. These and other features can provide a powerful and flexible Consumer-to-Business commerce facilitator solution.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions.

The electronic instructions, processes and operations of the inventive system described below with respect to all of the logic flow diagrams may include the manipulation of signals by a processor and the maintenance of these signals within data structures resident in one or more memory storage devices. For the purposes of this discussion, a process can be generally conceived to be a sequence of computer-executed steps leading to a desired result.

It should also be understood that manipulations within the computer are often referred to in terms such as listing, creating, adding, calculating, comparing, moving, receiving, determining, configuring, identifying, populating, loading, performing, executing, storing etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines may be used with the following process in accordance with the teachings described herein.

The invention may comprise a computer program or hardware or a combination thereof which embodies the functions described herein and illustrated in the appended flow charts. However, it should be apparent that there could be many different ways of implementing the invention in computer programming or hardware design, and the invention should not be construed as limited to any one set of computer program instructions.

Certain steps in the processes or process flow described in all of the logic flow diagrams referred to below must naturally precede others for the invention to function as described. However, the present invention is not limited to the order of the steps described if such order or sequence does not alter the functionality of the present invention. That is, it is recognized that some steps may be performed before, after, or in parallel other steps without departing from the scope and spirit of the present invention.

Further, a skilled programmer would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer implemented processes will be explained in more detail in the following description in conjunction with the remaining Figures illustrating other process flows.

Exemplary Computer System

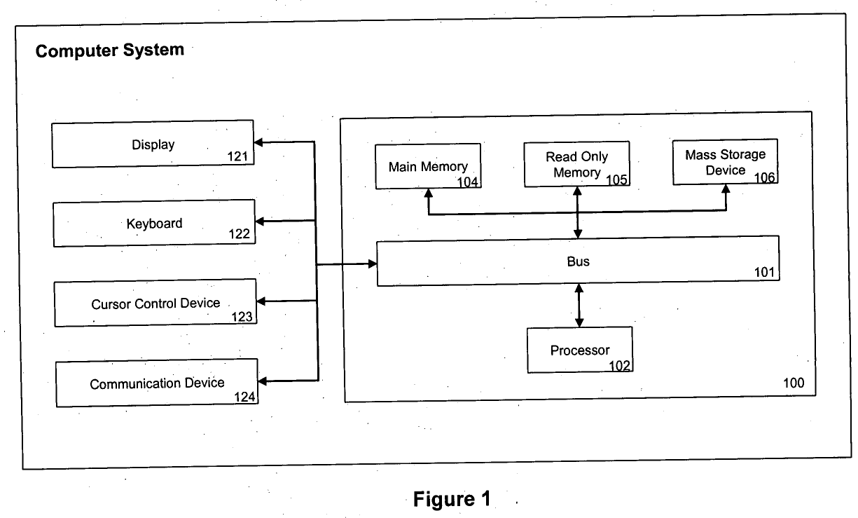

FIG. 1 illustrates a computer system 100 representing an exemplary target system upon which features of the present invention may be implemented. Computer system 100 comprises a bus or other communication means 101 for communicating information, and a processing means such as processor 102 coupled with bus 101 for processing information. Computer system 100 further comprises a random access memory (RAM) or other dynamic storage device 104 (referred to as main memory), coupled to bus 101 for storing information and instructions to be executed by processor 102. Main memory 104 also may be used for storing temporary variables or other intermediate information during execution of instructions by processor 102. Computer system 100 also comprises a read only memory (ROM) 105 and/or other static storage device 106 coupled to bus 101 for storing static information and instructions for processor 102.

A data storage device 106 such as a magnetic disk or optical disc and its corresponding drive may also be coupled to computer system 100 for storing information and instructions. Computer system 100 can also be coupled via bus 101 to a display device 121, such as a cathode ray tube (CRT) or Liquid Crystal Display (LCD), for displaying information to an end user. Typically, an alphanumeric input device 122, including alphanumeric and other keys, may be coupled to bus 101 for communicating information and/or command selections to processor 102. Another type of user input device is cursor control 123, such as a mouse, a trackball, or cursor direction keys for communicating direction information and command selections to processor 102 and for controlling cursor movement on display 121.

A communication device 124 is also coupled to bus 101. The communication device 125 may include a modem, a network interface card, or other well-known interface devices, such as those used for coupling to Ethernet, token ring, or other types of physical attachment for purposes of providing a communication link to support a local or wide area network, for example. In any event, in this manner, the computer system 100 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 100 will vary from implementation to implementation depending upon numerous factors, such as price constraints, performance requirements, technological improvements, and/or other circumstances.

It should be noted that, while the steps described herein may be performed under the control of a programmed processor, such as processor 102, in alternative embodiments, the steps may be fully or partially implemented by any programmable or hardcoded logic, such as Field Programmable Gate Arrays (FPGAs), TTL logic, or Application Specific Integrated Circuits (ASICs), for example. Additionally, the method of the present invention may be performed by any combination of programmed general purpose computer components and/or custom hardware components. Therefore, nothing disclosed herein should be construed as limiting the present invention to a particular embodiment wherein the recited steps are performed by a specific combination of hardware components.

Core Technology Platform

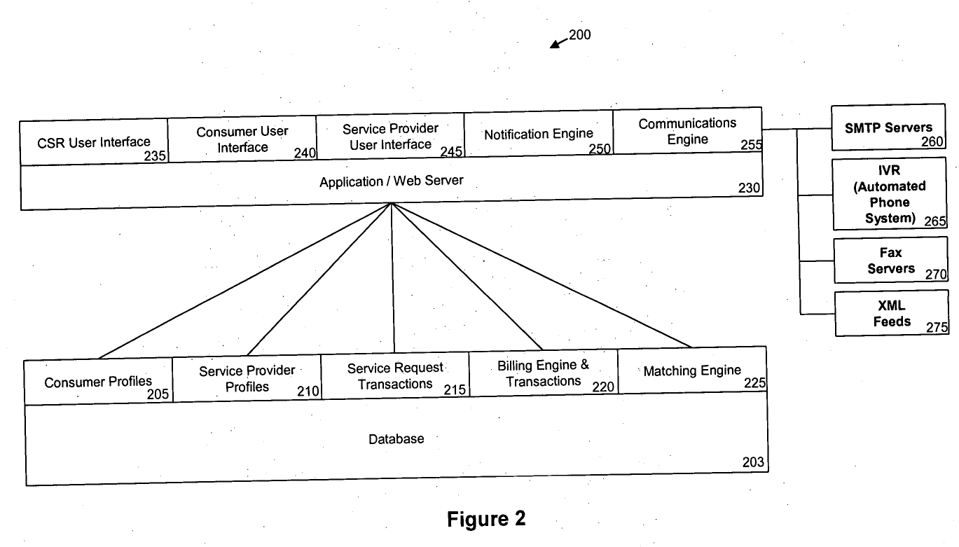

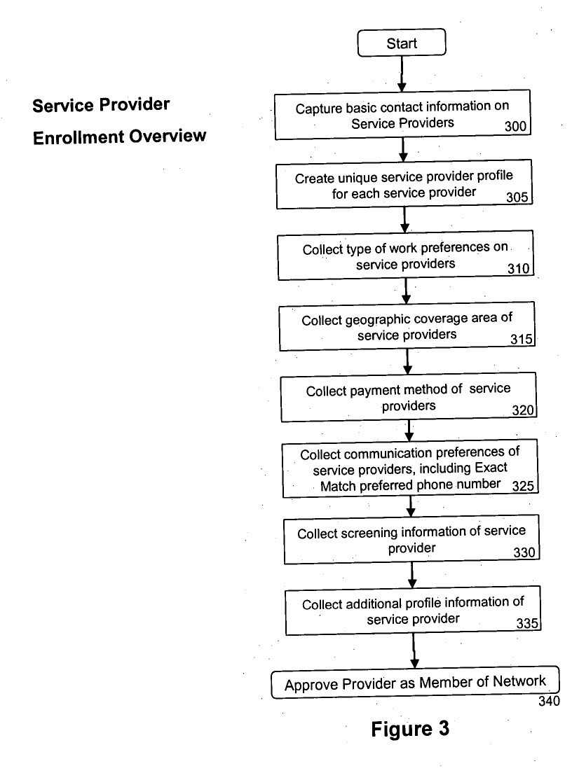

FIG. 2 illustrates some core components of an exemplary and inventive matching system 200. The components of the inventive matching system 200 used for connecting ready-to-act consumers and prequalified service providers may include, but are not limited to the following:

Application/Web Servers 230

Application/Web Servers 230 can be used to host the software performing each of the aspects of the present invention including the Customer Service Representative (CSR) user interface 235, Consumer User Interface 240, Service Provider user interface 245, Notification Engine 250, and Communications Engine 255. Each of these interfaces represents a different access to the database 203. The CSR user interface 235 is a Customer Relationship Management (CRM) website that is used to create and manage service provider accounts. The Consumer user interface 240 is a website that can display service provider profiles and can extract a description of the consumer's service need and contact information. The Service Provider user interface 245 is a website that enables service providers to manage their profile information and the leads that have been sent to them by the inventive matching system 200. The Notification Engine 250 determines which service providers should be notified of new leads, and the order in which those providers should be contacted. The Communications Engine. 255 is used to deliver various communications to both the consumer who has used the inventive matching system 200 to get matched to service providers, and the service provider who was matched successfully to that consumer with the inventive matching system 200. Communications are initiated using a consumer's selected preferences. Communications vehicles include, but are not limited to, e-mail, cell-text messaging, pager, fax and automated phone calls. The communications engine 255 can interact with various external mechanisms in order to deliver messages including (but not limited to):

Simple Mail Transfer Protocol (SMTP) servers 260 can be used to send and receive e-mail, pager and cell text messages to any of a consumer's or service provider's personal devices (cell phone, personal computer, etc) that are capable of receiving such communications.

Interactive Voice Response (IVR) 265 can be used to automate communications via telephone, the IVR 265 can initiate a call to a service provider or receive an inbound phone call, gather certain pieces of information from the consumer in an automated fashion, and ultimately connect the consumer and the service providers (via the phone) based on the appropriate criteria being met. Note the IVR 265 of the inventive matching system 200 can also be used to route the consumer to a customer service representative (CSR), who may use an CSR User Interface 235 of the inventive matching system 200 to help connect the consumer to the matching SP.

Fax servers 270 can be used to deliver the consumer's contact information to the Service provider's business fax machine. This external mechanism 258 can comprise commercially available servers that convert text based e-mails into a fax document.

XML Feeds 275 can comprise any number of customized feeds that allow the inventive matching system 200 to deliver leads directly into a service provider's CRM tool through an agreed upon custom format and protocol.

Database 203

The inventive matching system 200 can also comprise a Database 203 that is used as the central data store for all of the data for the matching process from start to finish. The database 203 can comprise one or more of the following:

Consumer Profiles 205 can comprise the location of the consumer and the contact information that should be used by the service providers to work with the requesting consumer.

Service Provider Profiles 210 can comprise all of the SP's profile information, business description, lead preferences for types of work and coverage areas, communication preferences for how to contact service providers, and screening information.

Service Request Transactions 215 can comprise data associated with a particular service request, including the location of the project, the consumer information, the description of the project, and the service providers who received the request.

Billing Engine & Transactions 220 can comprise data associated with billable events.

Matching Engine 225 can comprise a logical layer used to analyze a service request as submitted by the consumer and, depending on the type of request, either verifying that a chosen service provider matches the criteria needed to serve the consumer, or create the pool of potential service providers that will be distributed to the consumer via the notification engine 250. The outcome of the match can be stored for posterity and billing purposes in the database.

Service Provider Enrollment as an “Approved” Service Provider

Referring now to FIG. 3, this figure illustrates some exemplary steps for enrolling service providers into the inventive matching system 200, which are used for creating the database of pre-screened service providers and creating a profile for each provider.

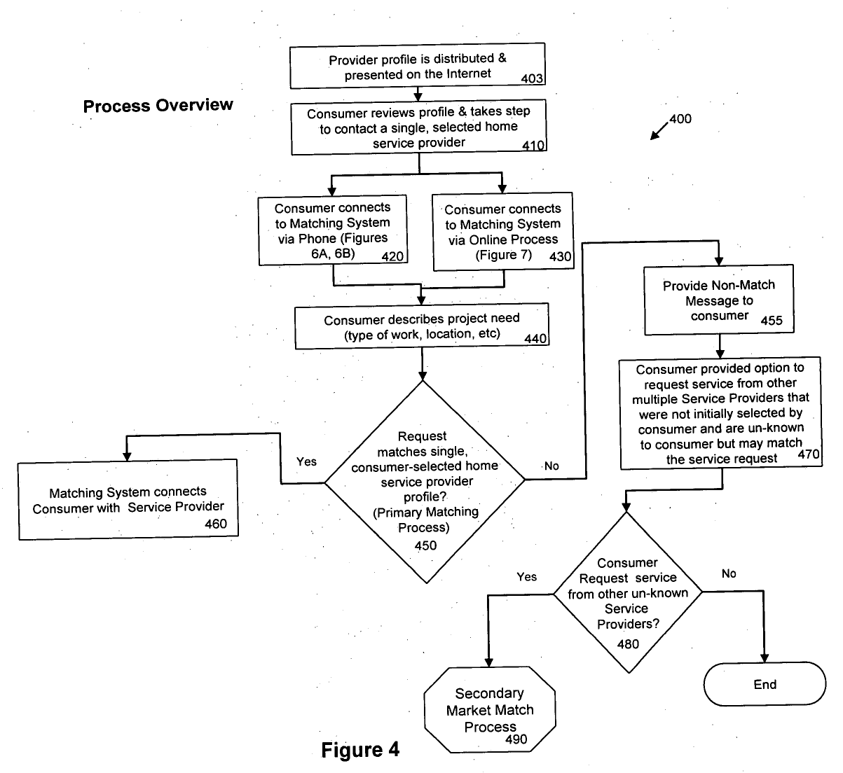

Either upon “first access” of the service, or when the service provider makes a decision to participate in the inventive matching system 200 and be eligible for inclusion in the Service Request Process (as illustrated in FIG. 4), the service provider is required to provide basic information in first step 300, such as business name, address and number of years in operation. The capture of this basic information in step 305 creates a unique service provider profile in the Database 203. To become an approved member of the network of pre-screened service providers, the inventive matching system 200 may require additional preference information in step 310 such as the type of work preferred by the service provider and the specific geographic areas in step 315 in which the service providers desire to provide their services. The inventive matching system may require a payment method in step 320 to be maintained in the database 203 for payment of lead fees or other fees resulting from interactions with the inventive matching system 200. Additional, in step 320, the system 200 may identify the spend cap or limit that particular service provider intends to operate under for a give time period such as a month. Spend cap is discussed in further detail below with respect to FIG. 4, and specifically, step 450.

Additionally, the inventive matching system may require communication preferences to be provided by each service provider in step 325, indicating the preferred method(s) for receiving lead notifications for consumer service requests from the inventive matching system 200. The methods available as of this writing include, but are not limited to, e-mail, cell-text (or SMS) messaging, facsimile transaction, alpha-numeric pager, or automated phone call. To be eligible for participation in the inventive matching system 200, service providers may be required to identify a preferred phone number to be used when a match is confirmed and so that the consumer and selected service provider can be connected via telephone.

Finally, to become an approved member of the network of pre-screened service providers, the inventive matching system 200 may require that each service provider meets certain eligibility, or screening, requirements in step 330 that are determined in part by the geography in which they work and the type of work they do. These factors may be used by the inventive matching system 200 to determine the specific licensing or insurance (or both) that is required. Additional profile information in step 335 may be collected and/or required for a service provider to become an approved member of the inventive matching system 200. After step 335, the service provider profile can be added as a member to the database or contact network as an “approved” provider.

General Process Overview for Exact Match Process

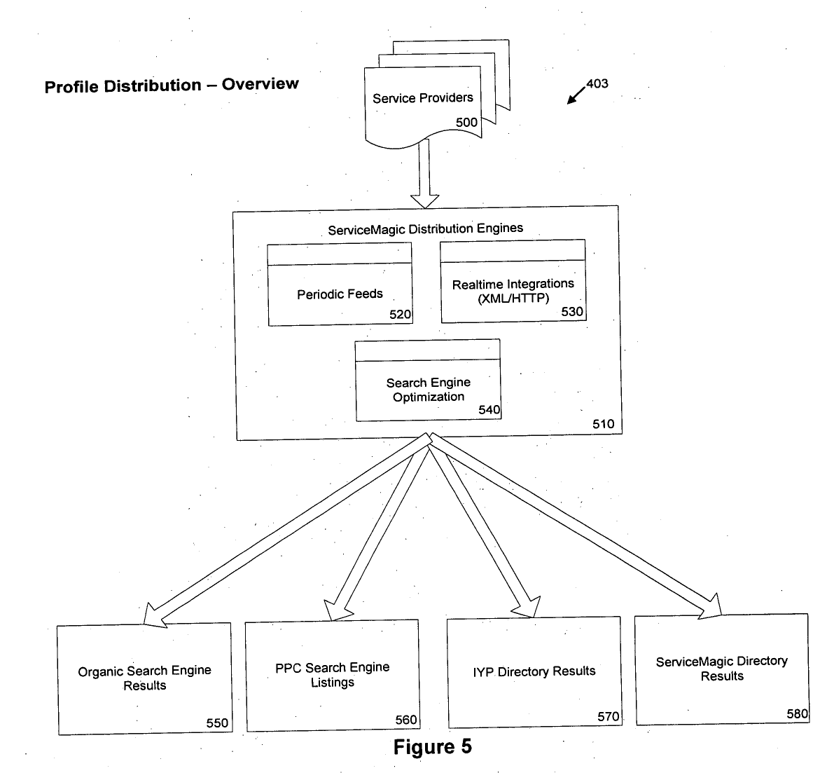

Referring now to FIG. 4, this figure illustrates a high-level process flow 400 for a primary matching process of the inventive matching system 200. Initially, in step 403 a service provider profile is distributed to various web sites that are likely to receive consumer traffic looking for help with home improvement projects (the distribution of the service provider profiles is further detailed in FIG. 5). A consumer who desires to access one of these web sites may enter search keywords at a search engine web site, for example “roofing contractor in Denver”. One or more service provider profiles can be presented by the search engine web site as a result for those search terms and displayed within the organic search results and/or the paid search results.

Within the organic search results, the search engine website, or more specifically the algorithms behind the search engine website, control whether or not the service provider's profile is presented. It is noted that the search engine website is not controlled or operated by the inventive matching system 200. For example, the search engine website could comprise third party websites known as of this writing such as Google.com or Yahoo.com. While the inventive matching system 200 does not control or operate the search engine websites, the inventive system 200 can generate web pages in such a way that the third party search engine websites will be able to index the web page of a service provider to be considered a result for all relevant search queries. The inventive matching system creates and stores in the database 203, a set of comprehensive and relevant keywords that most appropriately describe the type of work that a service provider performs, as well as the areas in which the work is performed. The web pages are then created by the inventive matching system 200 by using methods that provide the best opportunity of the newly created web page to be indexed by search engines, including the following: 1) using descriptive page titles, 2) including description and keyword meta tags, 3) opting to use text in place of images wherever possible, 4) including keywords within link text wherever possible, and 5) formatting the URL's of these pages in such a way that “spiders” or “bots” of the third party search engine websites can follow them and get access to the contents of the pages.

For paid search results, the inventive matching system 200 has a much more direct opportunity to determine whether or not the service provider's profile is presented. In this paid search result context, the results of search queries are determined by the bids that are associated with a service provider's “advertisement”. In certain third party search engines, the ranking on the page is based not only on the amount of the bid, but also on the corresponding click-through rate of the advertisement. In this way, a third party search engine can maximize their revenue by ranking the “advertisements” that generate the most revenue based on the bid price multiplied by the click-through rate. The inventive matching system 200 can apply various bid amounts to selected keywords and keyword combinations in an effort to generate exposure for its service providers who are in the database of the inventive matching system 200. Additionally, the inventive matching system 200 and/or its operators can determine the content to display within the service provider's advertisement to generate the most click-through activity. The optimal content, defined as that content which generates the highest click-through rate, is determined by conducting frequent tests across a network of providers.

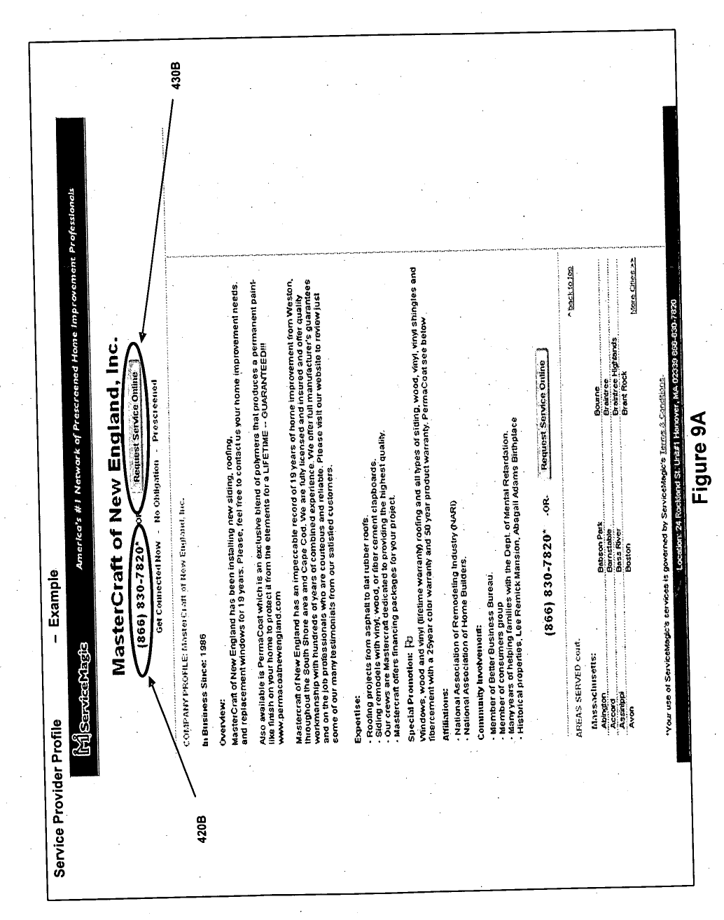

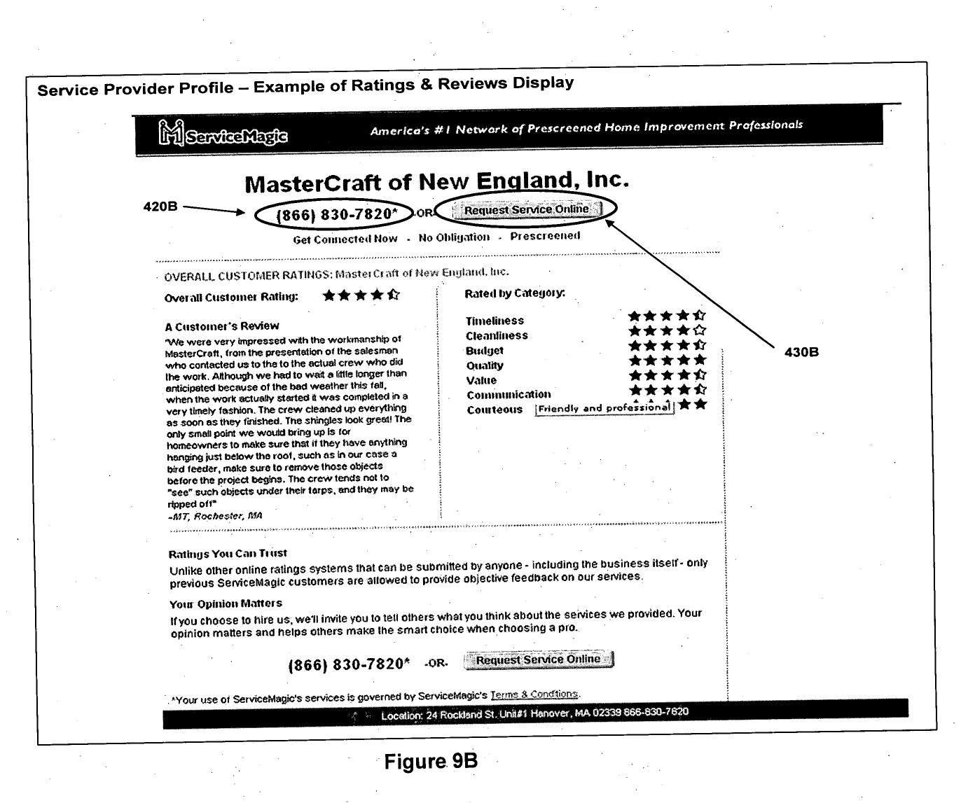

Once presented with a service provider advertisement, in step 410, a consumer reviews the content provided to make a decision about whether or not to contact a single home service provider. The process by which a consumer attempts to make contact with a selected, single service provider is determined by the third party web site on which the service provider's advertisement is displayed. A consumer may choose to contact a service provider based on the contact information being presented within the advertisement, as in the case of a telephone number being presented as part of the search results (See 420B of FIG. 9A), or the consumer may be required to click-through to the provider profile to access the contact information (See 430B of FIG. 9B).

Typically, the consumer will click on a link of a single home service provider within the advertisement to be directed to the single service provider's web page. A third party web site may choose to present a selected service provider's profile on a web site controlled by the third party, though most commonly the web page displayed after a consumer clicks-through is the web page hosted by the inventive matching system 200 (See FIG. 402). Either of these methods serve the purpose of presenting the selected, single home service provider's profile information to consumers. The intent of the matching system 200 is to present the consumer with adequate content so they are able to make a decision whether they would like to contact a single home service provider or continue a search elsewhere. The content presented within a single home service provider's profile can include, but is not limited to, the following information, and may be presented on multiple inter-linking web pages: service provider name, service provider logo, service provider overview, number of years the service provider has been in a field of business, service provider expertise, current promotion, awards the service provider has won, service provider affiliations, community involvement, type of services offered, cities in which the service provider provides service, previous customer ratings & reviews (See FIG. 412), screening criteria that the service provider passed to be admitted into the inventive matching system 200, and photos and descriptions of projects the service provider has previously completed.

To contact a selected single home service provider, a consumer can be presented with a telephone number (See 420B of FIG. 9A) that is unique to the home service provider or a hypertext link to request service on-line (See 430B of FIG. 9B) (or both).

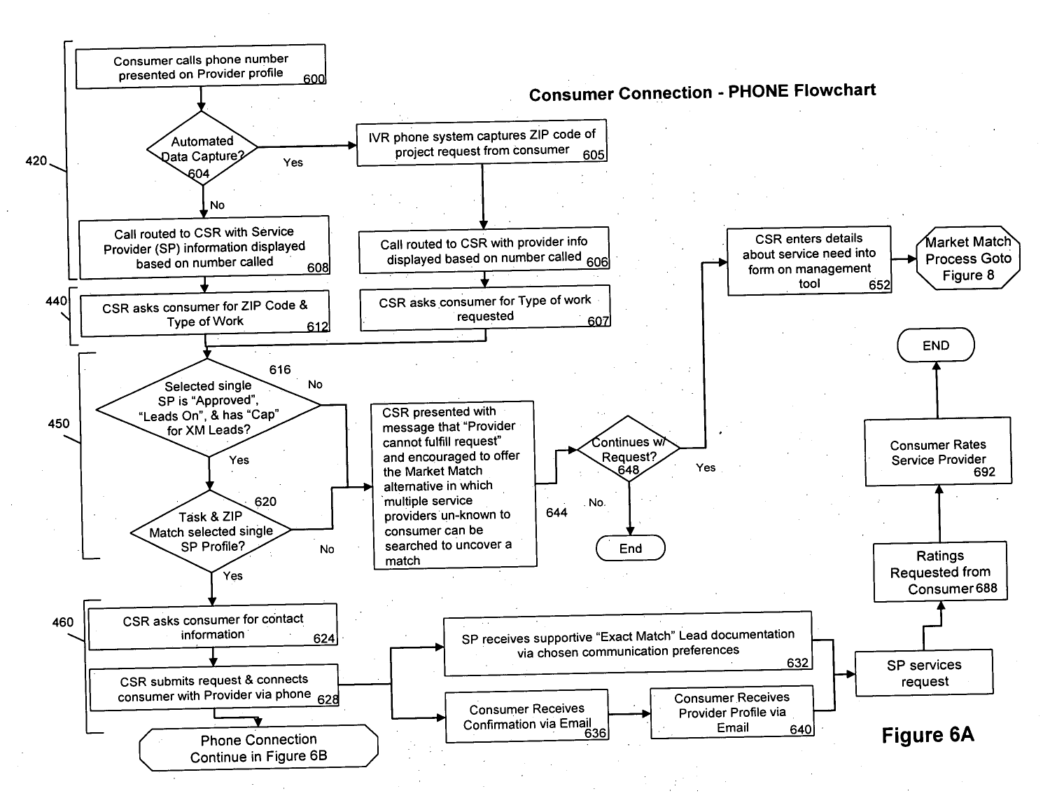

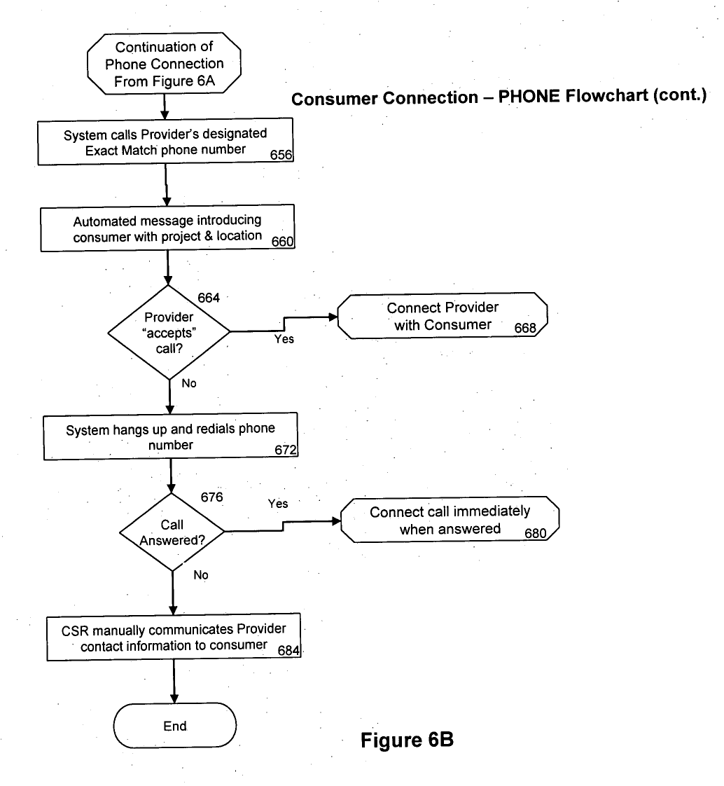

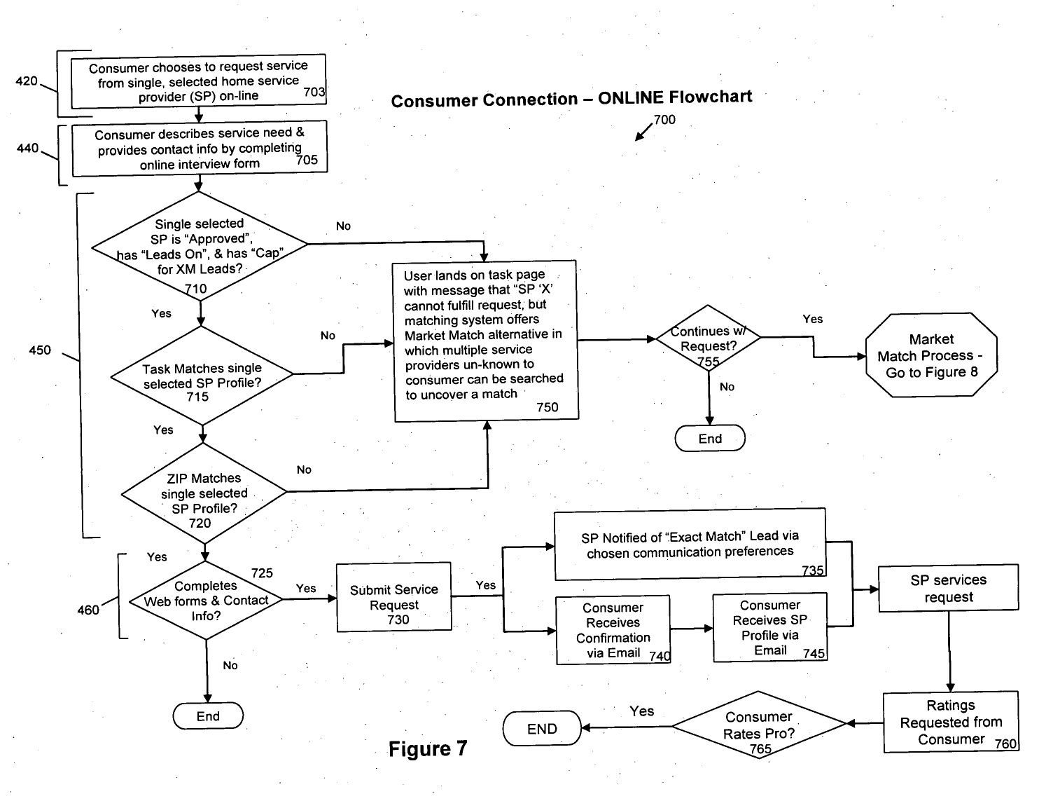

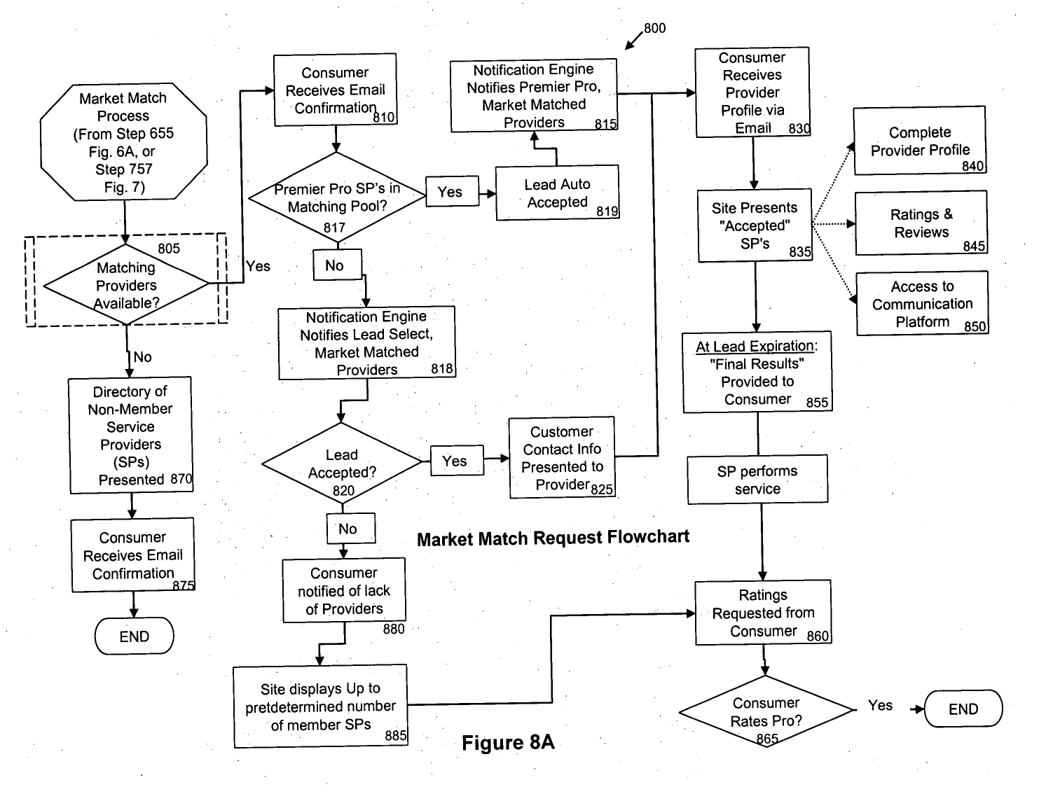

In step 410, if the consumer contacts the selected single home service provider by calling the telephone number as described in step 420, the consumer is routed to a phone system of the inventive matching system 200 (this process is further described in FIG. 6). Alternatively, in step 410, if the consumer clicks the hypertext link to request service from the single home service provider on-line, the consumer is presented in step 430 with a web site managed and operated by the inventive matching system 200 that enables the consumer to describe a service need by entering information into forms presented on a series of web pages in step 440 (this process is further described in FIG. 7).

In both the instances of step 410 (using the phone system or computer network), the inventive matching system 200 is the agent for the service provider. Thus, any phone call made by the consumer to the selected single home service provider is answered by an operator of the inventive matching system 200 and not the service provider. When answering a call on the behalf of the selected single home service provider, the operator of the inventive matching system 200 can state the service provider's name. Meanwhile, if a consumer decides to select the hypertext link for a selected single home service provider, the web site described above can present the home service provider's name very prominently.

Regardless of whether the consumer connects with the inventive matching system 200 via the phone or via the web site, the system 200, acting as the agent of the home service provider, can gather the details of the consumer's service need in step 440 to determine whether or not the selected service provider can fulfill the consumer's service request. The matching engine in step 450 can compare the ZIP code of the service request and the specific type of work in the service request with the data stored in the database 203 of the inventive matching system 200 for the single home service provider selected by the consumer. If the ZIP code of the service request is included in the selected service provider's profile, and the type of work in the service request is included in the selected service provider's consumer lead profile, then the potential for a match between the consumer and the service provider chosen by the consumer may exist.

Additionally, the matching engine 225 in step 450 queries the database 203 to confirm that the status of the single home service provider that has been selected by the consumer is “approved”, that they are currently accepting leads, and that they have spend cap available.

An “approved” status that is verified in step 450 by the system 200 refers to a condition that is checked against each provider within the database 203, based on each service provider meeting certain criteria. This criteria for “approved status” can include information such as a service provider maintaining appropriate state level licensing that is required to perform the type of work that is set forth in the service provider's profile, maintaining a valid payment method in the system 200 (in which the system 200 can automatically collect payment for providing one or more consumer leads), verifying that insurance information for a service provider is current, and other like criteria. FIG. 3 discussed above highlights exemplary steps used to collect information in order for a service provider to become an approved member of the database 203. To maintain the “approved status”, a provider must keep their licensing up to date, payment method up to date, insurance up to date, etc. One of ordinary skill in the art recognizes that other like criteria are not beyond the scope of the invention.

The status of “accepting leads” that is verified in step 450 by the system 200 can refer to the ability that the system 200 allows for a service provider to turn his or her ability to receive leads “off” and “on” again. If a service provider has too much work, for example, and is not able to serve additional customers, he or she may choose to turn their leads reception “off” for a period of time. Each service provider of the system 200 has the ability to turn their leads reception “on” or “off” by selecting an option from a website of the system 200. The service providers also have the ability to turn their leads “on” or “off” by communicating that desire to a customer service representative who can indicate that preference by interacting with the CSR user interface 235 on behalf of the service provider.

The status of “available spend cap” that is verified in step 450 by the system 200 refers to a limit, often measured in a dollar value of leads, that a service provider can indicate that he or she would like to receive over a given time period. As the system receives new service requests that are distributed to a particular service provider, the service provider consumes this spend cap since the system 200 can charge each service provider a fee for one or more consumer leads. If the provider has already received the dollar amount of leads according to his or her selected spend cap or limit, or if the spend cap is slightly exceeded, a service provider will not be able to receive a particular lead that is available over the spend cap. It should be noted that the spend cap available can be pro-rated over the course of the time period (a month) so that the leads are not distributed to the provider in the first few days of the time period, rather the intent is that the lead volume can be spread evenly over the course of the time period.

If all of the aforementioned criteria are met by the individual or single home service provider selected by the consumer, then the service request is considered a match between the consumer and the selected service provider and the two parties can be connected by the system 200 in step 460 (this process if further described in FIG. 6 for telephone service requests, and in FIG. 7 for on-line service requests).

If any of those criteria are not met in step 450, then in step 455, the inventive matching system 200 will notify the consumer with appropriate messaging to indicate that the single service provider that was selected by the consumer is not able to meet the consumer's service need. The consumer is then provided an option in step 470 to get matched to other pre-screened service providers with a secondary matching process with un-known or un-selected service providers relative to the consumer, whose profiles, as stored in the database 203, may meet the service request criteria of the consumer.

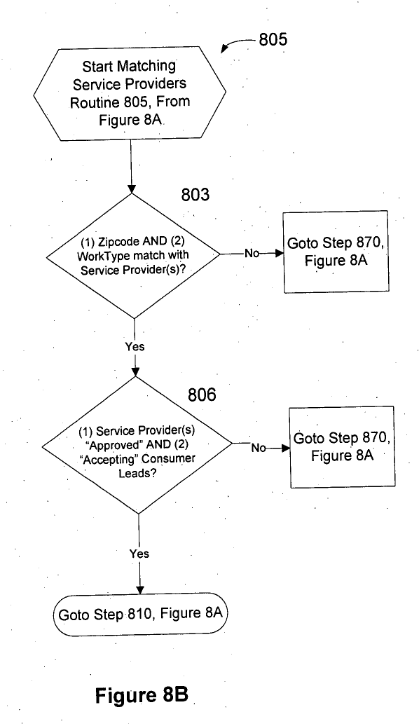

If the consumer decides against matching to other unknown (home service providers not initially selected by the consumer) home service providers, through the secondary matching process, then in step 480 the process ends and any contact information or service request information gathered from the consumer is not stored in the database 203. If, however, the consumer decides to get matched to other service providers, then in step 480 a secondary matching process is initiated (this secondary matching process is further described in FIG. 8). Service Provider Profile Distribution to Allow Consumers to Select a Single Provider Referring now to FIG. 5, this figure illustrates various methods used to distribute service provider profiles to third-party web sites that are likely to receive consumer queries or searches for help with home improvement projects. FIG. 5 corresponds to step 403 of FIG. 4. There are at least three methods by which service provider profiles 500 can be distributed by the inventive matching system 200.

A first search engine optimization method 540 presents a service provider profile 500 by displaying the profile 500 as an organic engine result 550. According to this method, the inventive matching system 200 does not overtly distribute the service provider's profile information; rather, the service provider's profile information is presented on a web site in such a way that search engines can access the information and catalog the web site appropriately, based on the service provider's profile information as well as the keywords and keyword phrases associated with the profile generated by the inventive matching system 200, both stored in the database 203. The web pages made through the search engine optimization 540 are generated by the inventive matching system 200 using methods that provide the best opportunity to be indexed by search engines, including, but not limited to, the following: 1) using descriptive page titles, 2) including description and keyword meta tags, 3) opting to use text in place of images wherever possible, 4) including keywords within link text wherever possible, 5) linking these to other pages that are contextual and relevant to the target query terms, and 6) formatting the URL's of these pages in such a way that “spiders” or “bots” of third party search engine websites can easily follow them and access the contents of the pages. The third party search engine websites can produce organic search engine results 550 based on the scan by the “spiders” or “bots”.

The application server 230 generates these pages dynamically based on the contents of the service provider's profile 210, and data that is relevant to the page being viewed. For text in place of images, operators of the computer system 200 can determine if text can communicate the information from the provider's profile as effectively as images. Text is usually more desirable because the search engine “spiders” or “bots” can read text, but cannot read images.

For descriptive page titles, most page titles will include some of (but not all) a service provider's name, overall rating score, City/State where the service provider does business, descriptive product name and sales text (example: “<Company Name> is a <rating score> Star Rated Home Improvement Pro in <City>, <State>”). THUS, THE COMPUTER GENERATES THE PAGE TITLES DYNAMICALLY based on rules.

For meta keyword and description tags, most of this content will include the content from the page title (although typically it will be re-arranged, or exclusive such that it is not a repeat of the same information). Other content that may be included in meta keyword and description tags includes descriptive product names (for all products a given service provider may support). THIS CONTENT can be GENERATED BY THE COMPUTER system 200 based on rules.

For text in place of images, operators of the computer system 200 can determine if text may be more suitable than images to attract business for a service provider. For link text, wherever a link is generated that points to a service provider's profile (for example from a directory) or within the service provider's profile (for example, a link to see a specific product that is covered by a service provider), the matching system can generate these links with either the service provider's name, or the descriptive name for the chosen product as the actual link text.

For formatting URLs, the matching system 200 may generate actual URL targets of service provider web pages in a dynamic fashion such that there are no query string parameters that might cause issues with search engine robots that try to traverse the URLs. Thus, a URL that is comprised of many dynamic pieces may appear to be a “Static” URL such that the bots do not discredit them.

See the following LRL as an example:

http://www.servicemagic.com/rated.ABCConstruction.1063937.html

This URL is a request for which is routed to a logical processor (servlet in this implementation) that parses the service provider's unique identifier (1063937) from the URL and uses it to construct the dynamic page.

A less “Search Friendly” implementation might use something more like the following URL:

http://www.servicemagic.com/ExactMatchServlet?userID=1063937.

The parameter at the end of this URL list might cause one to suspect that this was a page generated from dynamic and therefore temporary data, rendering it less valuable to the Search Engine.

Another second method 520 periodically feeds custom data files to third parties such that these parties have the ability to display the service provider profiles 500 in whatever manner they deem appropriate, with the complete set of data or a partial set of data. To facilitate this method of distribution, the files that are periodically sent to the third party are made up of content included in the service provider profile, as well as keywords and keyword phrases pertaining to the superset of tasks for which a service provider could be profiled, and to the superset of geographic locations for which a provider could be profiled. Additionally, the files may contain bid amounts, representing the amount of money that should be bid for a particular service provider for a particular keyword or set of keywords. There may also exist custom categorization whereby the parties have agreed on mappings between the two companies taxonomies. All of this data (profiles, mappings, keywords, and bid amounts, etc) can be stored in the database 203. These data elements form the superset of data that can be distributed to the third party web sites with the periodic feed method 520 illustrated in FIG. 5.

The periodic feed method 520 for the profiles 500 can be coded to conform to an agreed upon specification between the operators of the matching system 200 and any given third party. They can be fully automated, and typically comprise a format (ex: tabular delimited text, or comma separated values text files); a delivery protocol (ex: file transfer protocol “FTP”, or e-mail); and a scheduling mechanism (typically using a scheduling feature of the Solaris computer operating system referred to as “CRON”).

The operators of the matching system 200 and the third party can agree on the format, protocol, and frequency of the periodic feeds 520. The operators of the matching system 200 can use software to extract the appropriate service provider profile information from the database 203, compiles that information into the format specified by the operators of the matching system 200 and the third party, creates a file containing the information, and delivers the files to the third party according to the frequency agreed upon by the two parties. This software can be executed by the communications engine application server 255 and can connect to the database 203 to retrieve the data intended to be delivered according to the agreed upon mechanism in the agreed upon format.

A third real-time integrations method 530 uses the same data as the periodic feed of data files according to the second method 520, but instead of waiting for the pre-determined time interval, the data files are updated in real-time. This means that when a change is made to the data, either by the service provider interacting with the service provider user interface 245 or by an update to the keywords or bid amount directly into the database, the updated data file is sent immediately to the third party web sites. This would likely be sent as an XML transaction over an HTTP connection directly to the system of the third party.

The real-time integration method 530 can be coded to conform to an agreed upon specification between the operators of the matching system 200 and any given third party. The method 530 can be fully automated, and can typically comprise of a format (ex: Extensible Markup Language “XML”); a delivery protocol (ex: Hypertext transfer protocol “HTTP”). Feeds of the profiles 500 are typically triggered either by a change in the system (ex: a company becomes enabled for the program) or triggered by a polling process that is looking for regular changes in an account of service provider stored in database 203 (ex: a new rating is submitted causing a Service Provider's rating score to change). Once a need for an update has been identified by the real-time integration method, a request is sent to the communication engine 255 to formulate the XML, and “post” the updated data to the third party.

The operator of the matching system 200 and the third party can agree on the format and protocol for the real-time integration. The matching system 200 can use software that extracts the appropriate service provider profile information from the database 203, compiles that information into the format specified by operator of the matching system 200 and the third party, creates a file containing the information, and delivers the files to the third party according to the frequency agreed upon by the two parties. This software can be executed by the communications engine 255 and can connect to the database 203 to retrieve the data intended to be delivered according to the agreed upon mechanism in the agreed upon format.

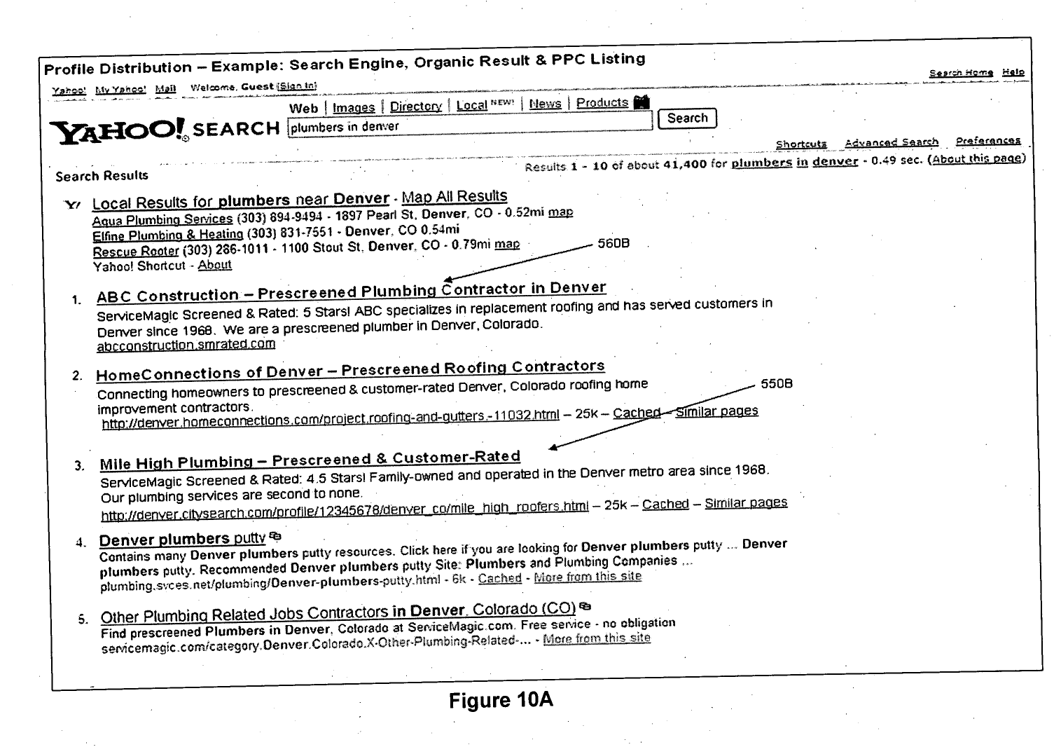

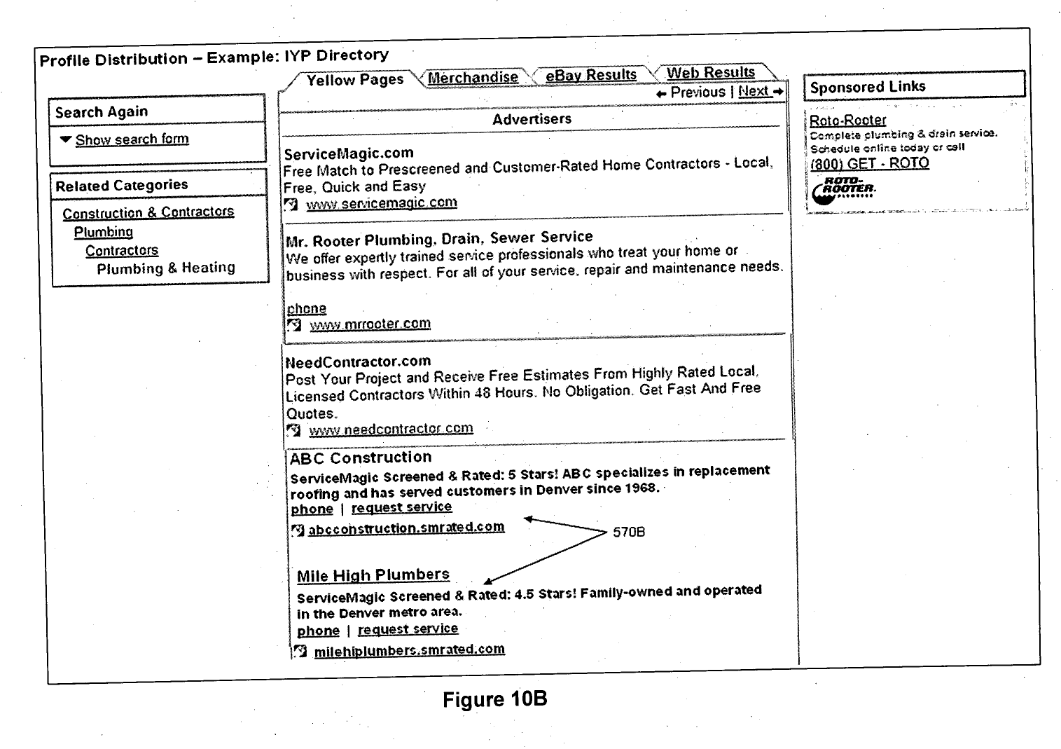

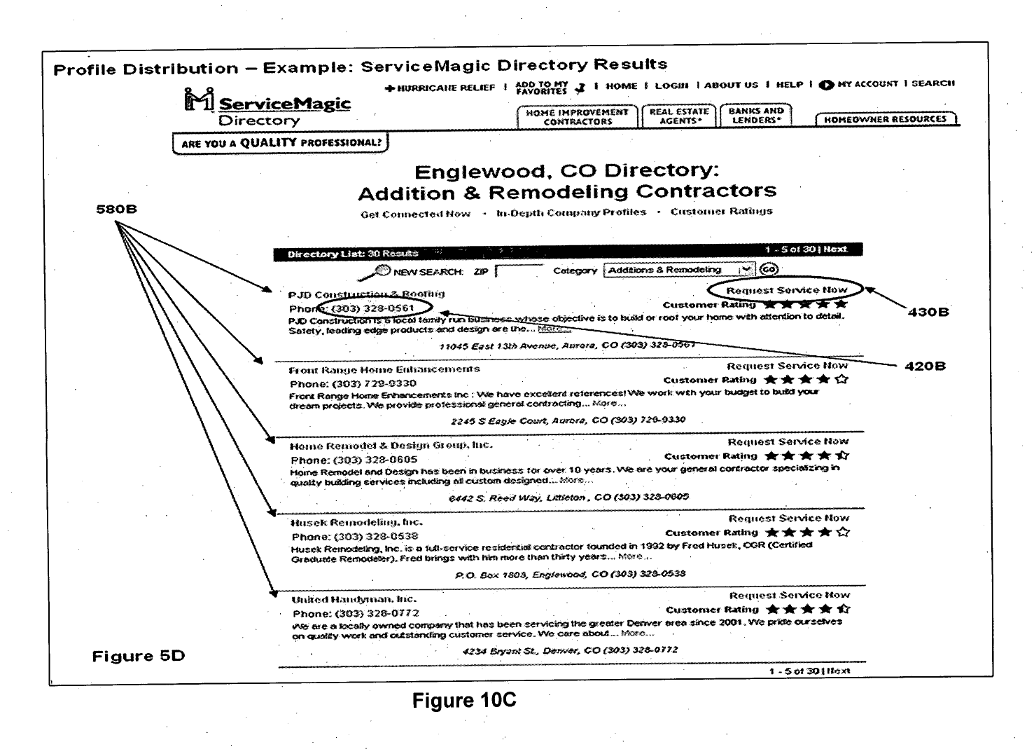

Once the data is distributed (by one of three methods discussed above) to the various web sites that are likely to receive consumer computer users looking for help with home improvement projects, the provider profiles are presented at the discretion of the third party web sites. This presentation could take many forms including, but not at all limited to, organic search engine results 550 (See also 550B of FIG. 10A), pay-per-click (PPC) search engine listings 560 (See also 560B of FIG. 10A), Internet Yellow Page (IYP) directory results 570 (See also 570B of FIG. 10B), or a directory of Exact Match service providers 580 generated by the inventive matching system 200 (See also 580B of FIG. 10C). Service provider profiles are not limited to their presentation on web sites. The directory of exact matched service providers 580 can also be distributed via other electronic vehicles, such as a personal digital assistant (PDA) and telephone directories, or non-electronic vehicles, such as a printed directory, or any other vehicle that could be used to convey the profile information.

Process for Telephone-based Exact Match Service Request

Referring now to FIG. 6A, this figure illustrates a process in which a consumer submits a service request using the telephone-based method of contact in steps 420-490 that are illustrated in FIG. 4. Initially, as part of the service provider's profile, a consumer is presented with a telephone number in Step 600 that is presented as one way in which the consumer may request service from a selected, single home service provider. Although this telephone number may appear to the consumer to be the service provider's telephone number, it is in fact a unique telephone number of the inventive matching system 200 and that may be assigned to a specific service provider and maintained in the database 203 of the inventive matching system 200.

The inventive matching system 200 can maintain tens of thousands of both local (nationwide) and toll free phone numbers that are provided by telephone company partners of the inventive matching system 200. These telephone numbers can be allocated to service providers based on coverage. Each service provider can be allocated at least one unique phone number, and may (for tracking purposes) be allocated more than one. Each of these phone numbers may be serviced directly with the IVR 265 of the inventive matching system 200.

Based on the telephone number of a selected, single home service provider called by a consumer, the system 200 is able to identify the single service provider whose profile contains the telephone number dialed. This information is maintained in the database 203 of the system 200. The system 200 can then interact with the consumer via an automated process (steps 605-607), or via a process (steps 608-612) facilitated by a Customer Service Representative (CSR) and a CSR user interface 235 provided by the inventive matching system 200. Using the automated process in step 605, and based on the profile information stored in the database 203, the system 200 is able to present information, to the consumer, about the single home service provider that was selected by the consumer.

For example, the system 200 could play a recorded message on the telephone that says “Thank you for calling ‘XYZ Construction’.” Additionally, the system 200 could obtain certain necessary data elements to ascertain whether the selected, single home service provider is a match for the consumer making the phone call. The data extracted could occur by using an IVR system 265 to interact with the consumer in an automated fashion and capture information related to the consumer's service need.

For example the interactive voice response (IVR) system 265 in step 605 could ask the question: “What's the ZIP code where the project will take place?” The consumer could provide this data by speaking into the telephone, whereby the IVR system 265 of the matching system 200 would utilize commercially available IVR “Speech to Text” or “Voice Recognition” technology to translate the voice into text for saving the data in the database 203. Additionally, the consumer could provide this data by using the touchtone keypad on the telephone and pressing the appropriate numbers to enter data, or to select an option from a menu of options presented to the consumer via pre-recorded messages.

Once it is determined that a call is a genuine attempt to obtain service from a selected, single home service provider, and after any requested data is captured, the call can be routed via a PBX “Hunt group” in step 606 to a specific customer service representative (CSR) who is an operator of the inventive matching system 200. When the data is captured, it can be referenced with the matching system by a unique key allowing the system 200 to again retrieve the data from the database 203 in the CSR User Interface 235 once the call is successfully routed.

In the alternative to the routing of the call to a PBX “Hunt group” in step 606 (and not illustrated in FIG. 6), the IVR system 265 could comprise an entirely voice automated system in which a consumer is presented with an audible list or menu of choices and the selection of these choices allows the system 200 to acquire specific consumer need information for completing a consumer service request that can be matched against the chosen or selected, single home service provider of the primary matching process or against multiple home service providers in the secondary market matching process.

In step 607, using commercially available PBX “CTI” (Computer Telephony Interface”) technology, the matching system 200 can launch a custom CUSTOMER RELATION MANAGEMENT (CRM) web page (See FIG. 613) on a customer service representative's (CSR's) desktop containing information specific to the call (referenced by the aforementioned “unique key”). Using the process facilitated by a CSR and the CSR user interface 235, and based on the profile information stored in the database 203, the system 200 is also able to display certain data elements from the service provider's profile on the CSR user interface 235. In steps 608 and 612, similar to step 612, this display enables the CSR to answer the telephone by including the service provider's company name in the greeting, for example “Thank you for calling ‘XYZ Construction’, a member of a pre-screened network of service providers. How may I help you?” The CSR is then presented with web pages in step 612 through the CSR user interface 235 that are designed to capture certain necessary data elements, such as zip code and the type of work or service requested, to ascertain whether the single selected home service provider is a match for this specific consumer need.

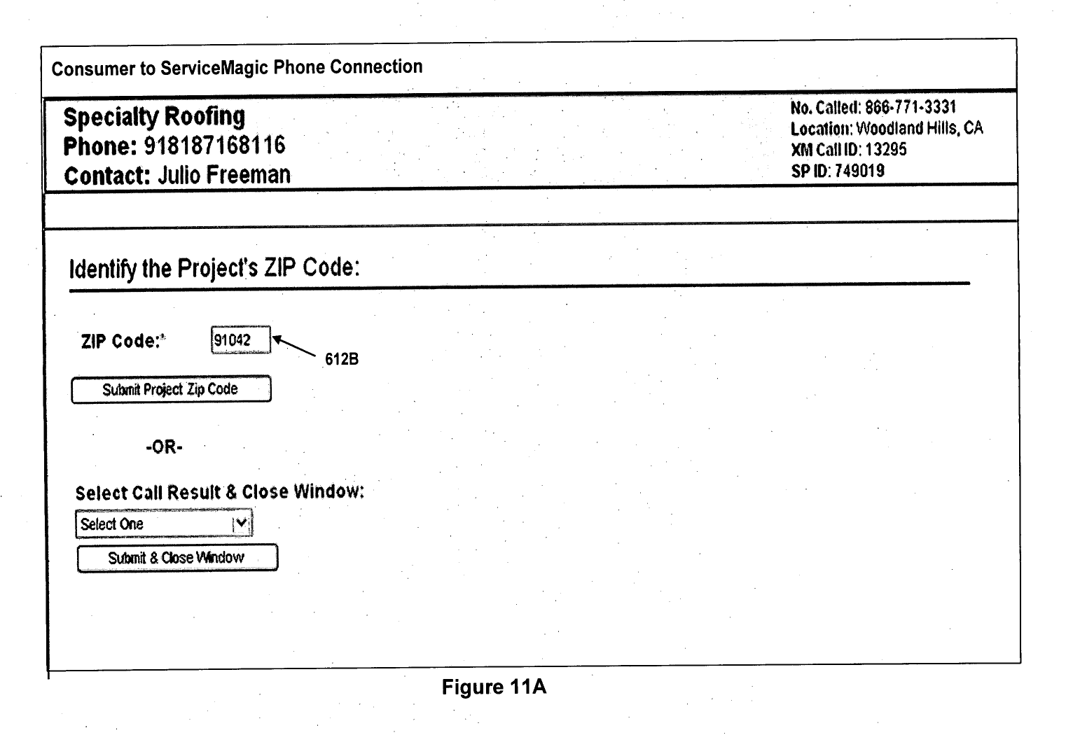

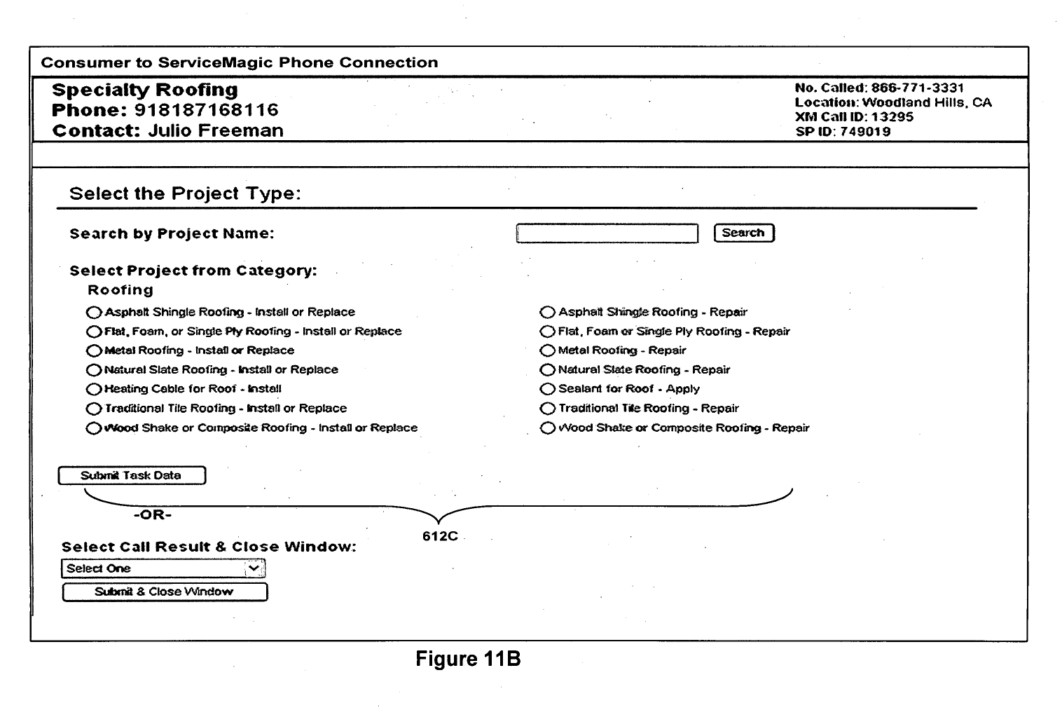

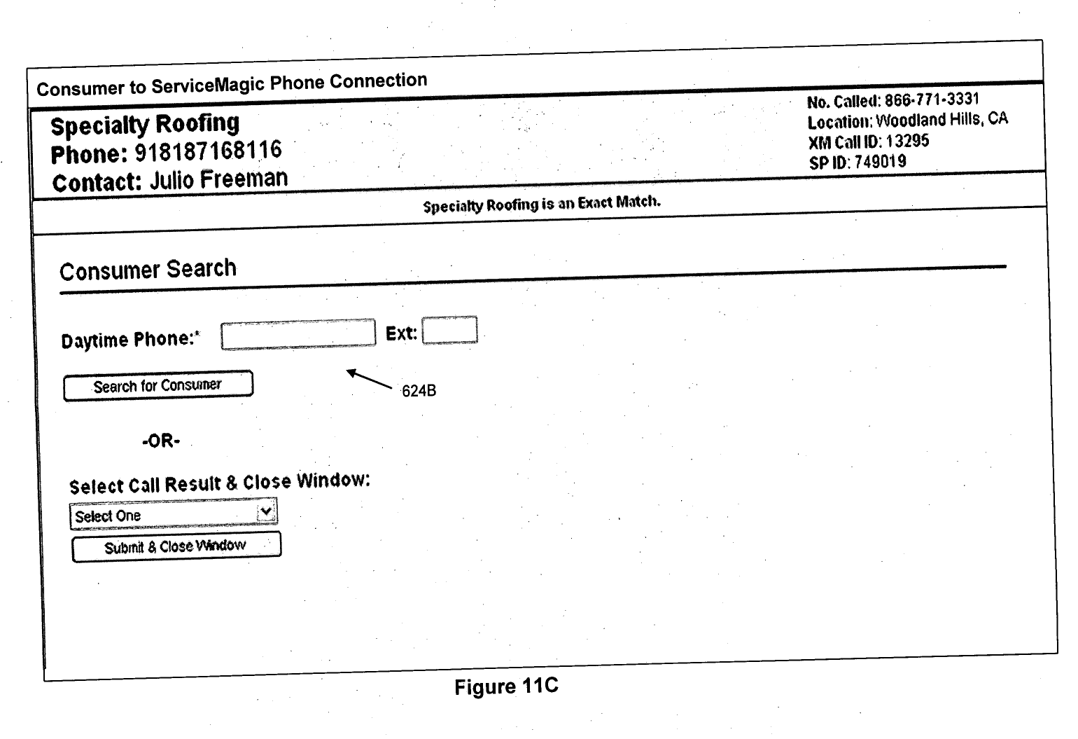

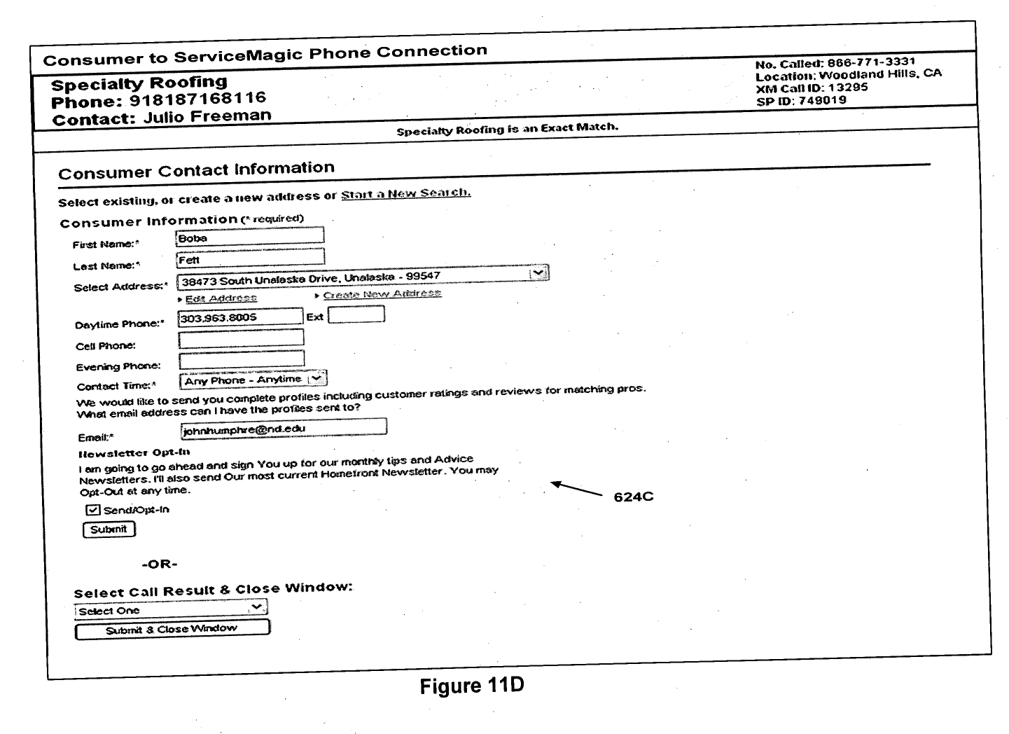

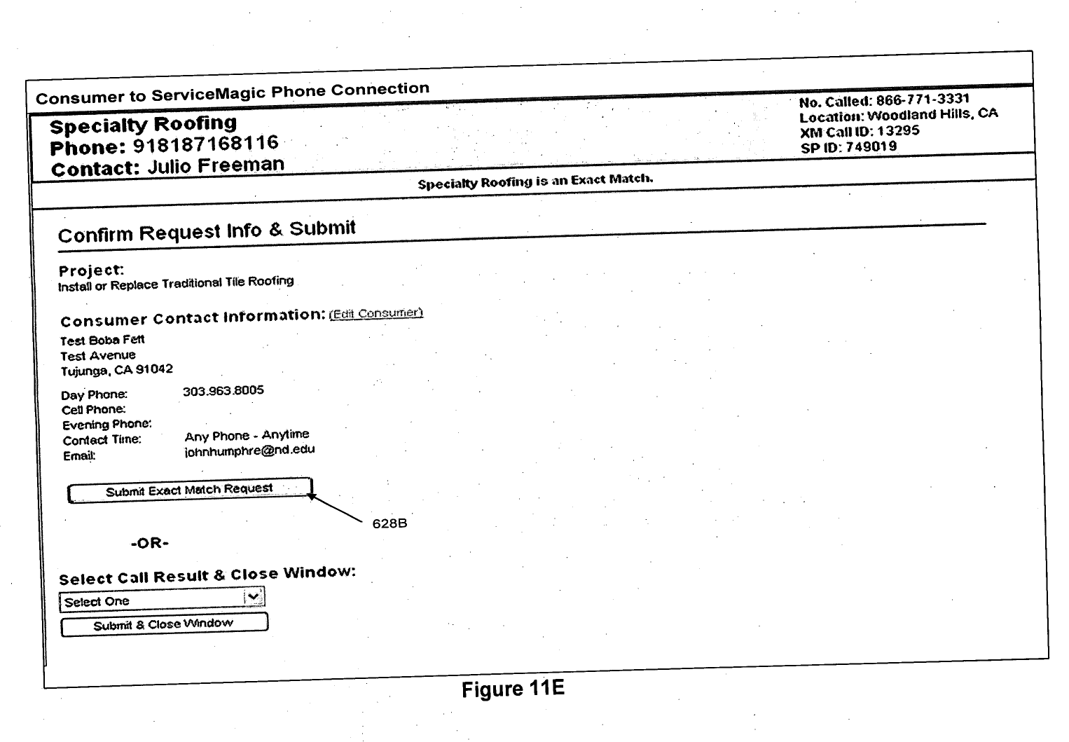

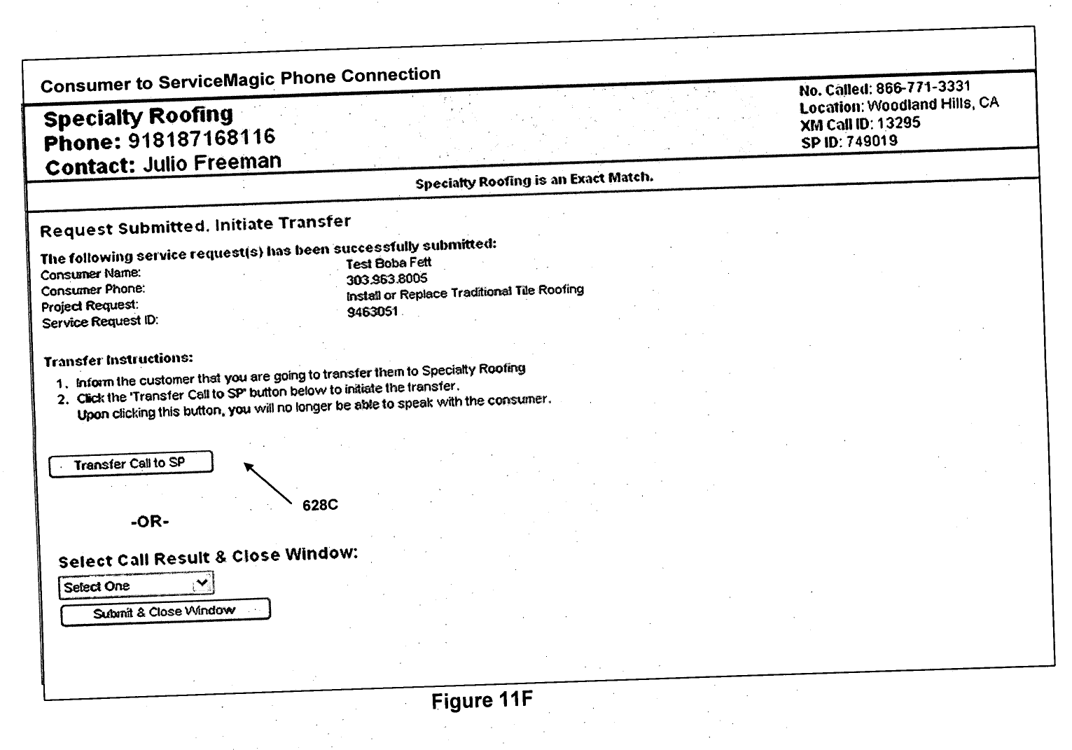

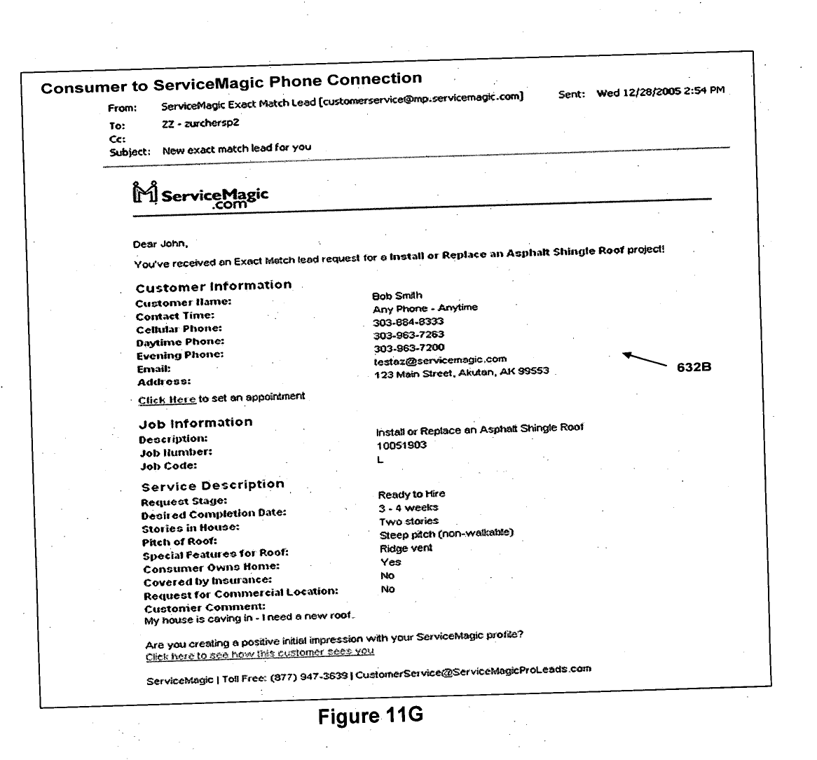

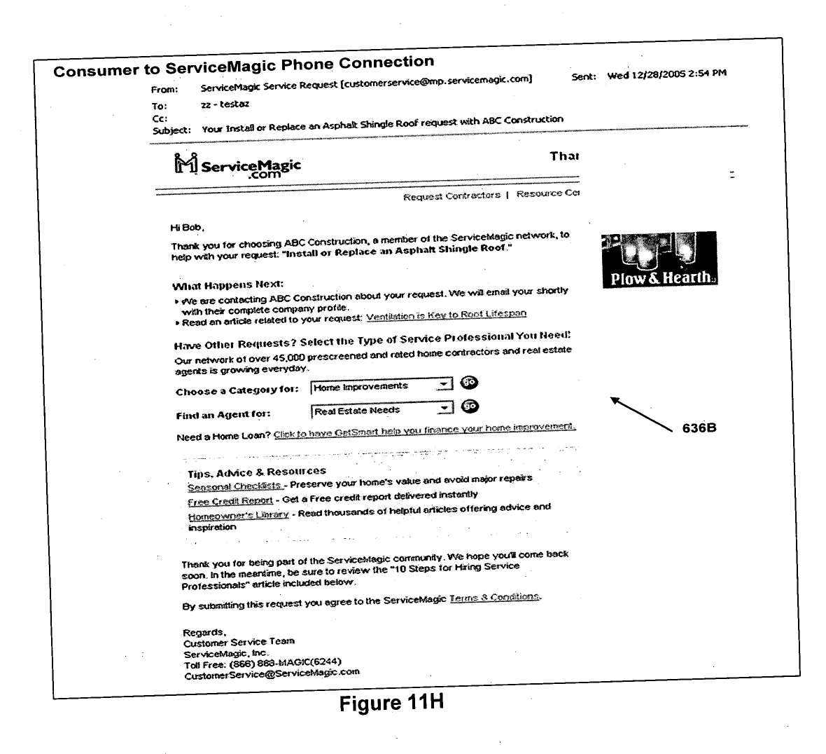

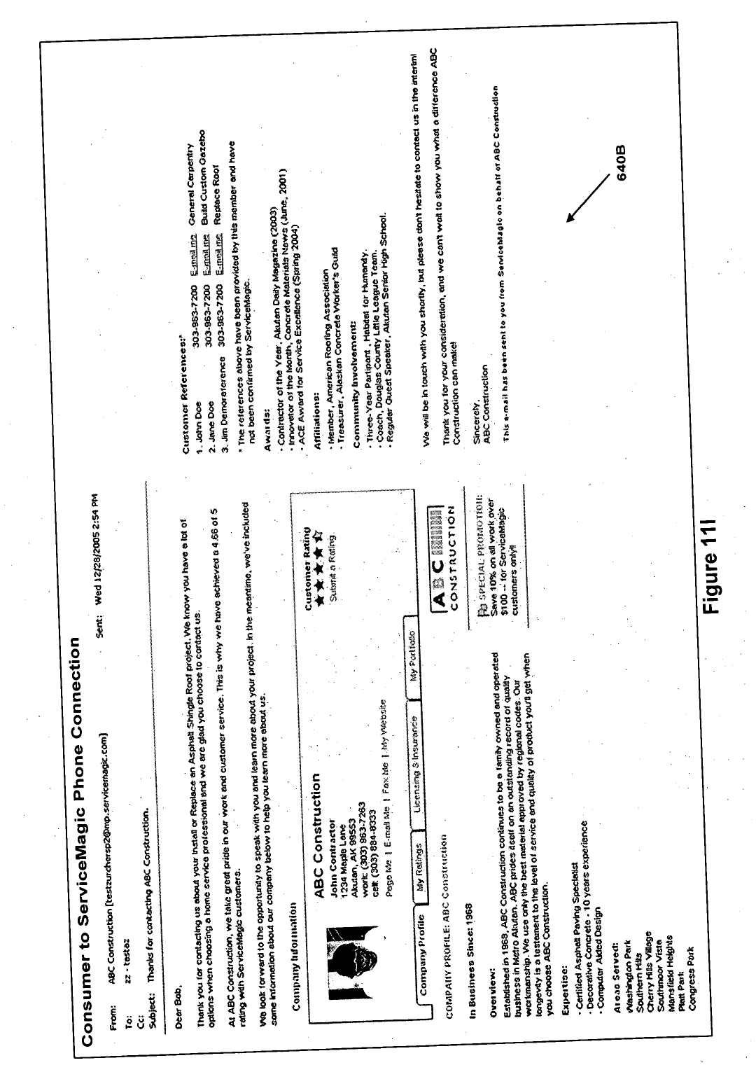

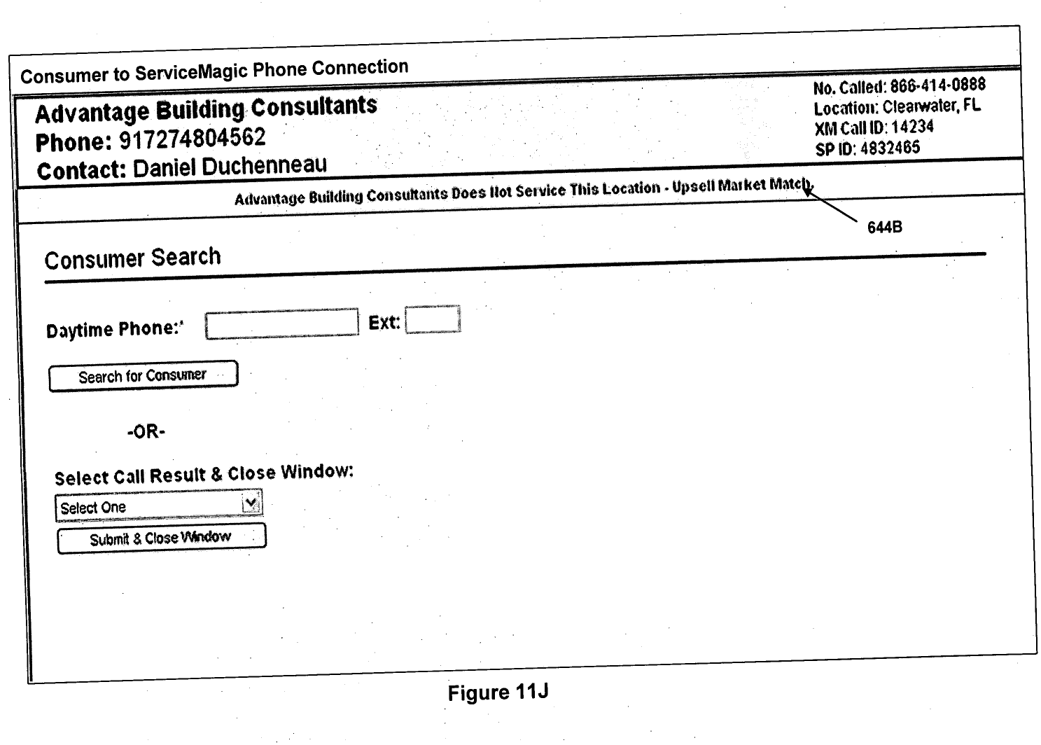

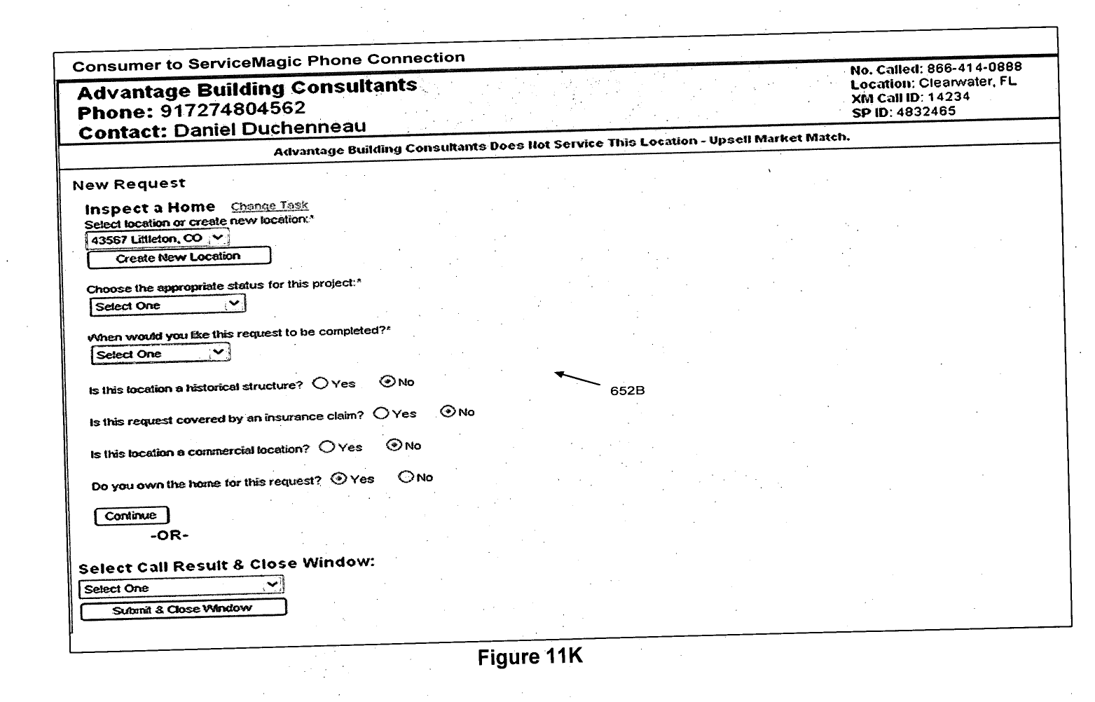

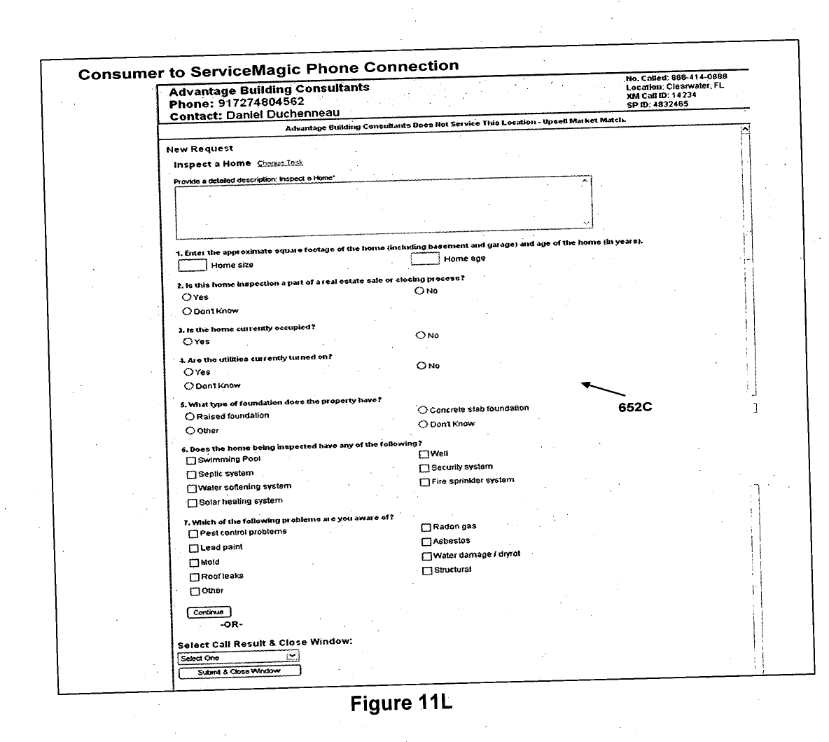

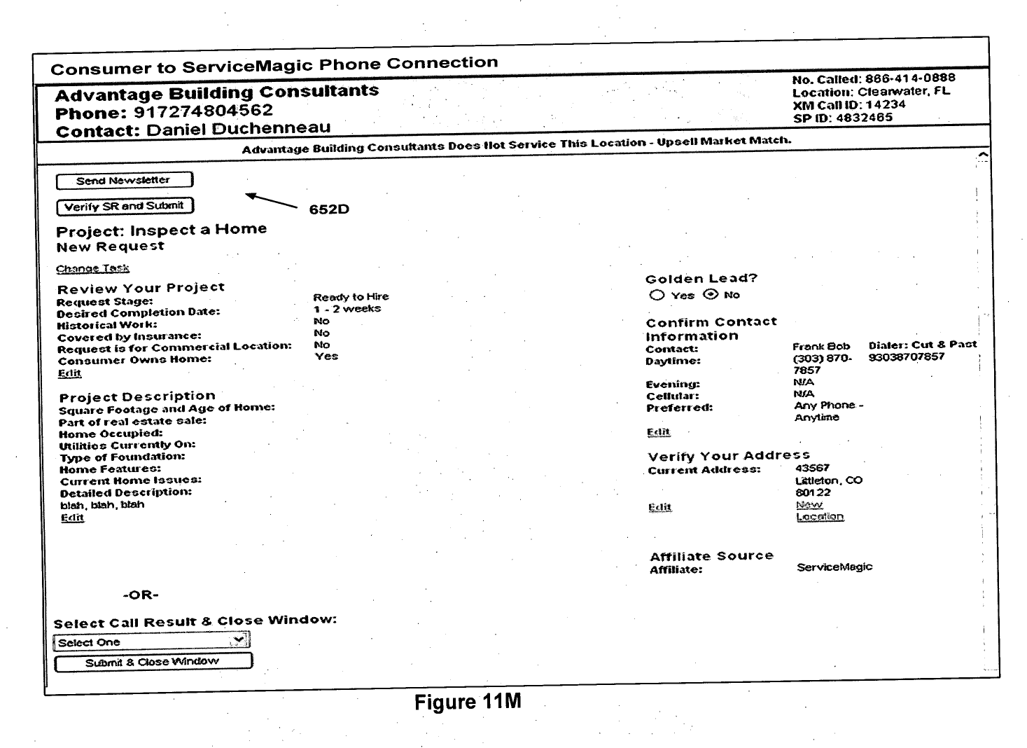

Referring briefly to FIG. 11A, this figure illustrates an example of a web page designed to capture a consumer's zip code 612B. Meanwhile, referring briefly to FIG. 11B, this figure illustrates an example of a web page designed to capture a consumer's type 612C of home service or work desired.

With the service request information captured from the consumer through either steps 608-612 or steps 605-607, the matching engine 225 can determine whether the single selected home service provider should be notified of the consumer's service need. The matching engine 225 in step 620 compares the ZIP code of the service request and the specific type of work in the service request with the data stored in the database 203 for the single home service provider that was selected by the consumer. If the ZIP code of the service request is included in the selected service provider's profile, and the type of work in the service request is included in the selected service provider's profile, then the potential for a match between the consumer and the single selected home service provider exists.

Additionally, the matching engine 225 in decision step 616 can check with the database 203 to confirm that the status of the single home service provider that was selected by the consumer is “approved”, that they are currently accepting leads, and that they have spend cap available. These three elements of “approved”, “accepting leads”, and “spend cap” of decision step 620 are fully described above with respect to overview decision step 450 discussed above with respect to FIG. 4. If all of the three criteria are met in step 620 and two criteria in step 616, meaning that the inquiry to decision steps 616 and 620 is positive, then the service request is considered an “exact” match by the system 200 between the consumer and the single home service provider that was initially selected by the consumer.

To complete the “exact” match service request process, the CSR in step 624 captures the contact information from the consumer by entering the consumer contact information into the CSR user interface 235. Examples of this CSR user interface 235 are illustrated in FIGS. 11C and 11D with specific input fields 624B and 624C. The information is compared by the inventive matching system 200 against the data contained in the database 203 to determine if the database 203 already contains a profile for the consumer submitting the current request.

If the data elements are found in the database 203 by the inventive matching system 200, the CSR confirms that the account previously existing in the database is the same consumer currently requesting service. If this is the case, then the account is re-used and the CSR confirms the pre-existing information, submits the service request (illustrated in FIG. 11E—see submit button 628B) and initiates the call transfer process (illustrated in FIG. 11F—see call transfer button 628C) in step 628 to connect the consumer with the selected service provider.

At the time the exact match service request is submitted, the database 203 is updated to include the consumer's service request information. This information is associated with both the consumer account 205 within the database 203 and also with the single home service provider profile 210 that was selected by the consumer. As a result, when the consumer and the selected single home service provider access their account, either by logging in to the website or by calling a CSR or other method, they are provided the information about all service requests that are associated with their accounts. Additionally, each consumer has access to the profile information of the service provider(s) (See FIG. 842) to whom his or her request has been matched and each matched service provider has access to the profile information of the consumers who have submitted service requests.

Also, at the time the service request is submitted, the Communications Engine 255 notifies the single selected service provider of the new consumer in step 632. Initially, the Communications Engine 255 queries the database 203 to determine which methods of communication are included in the selected single home service provider's profile. The most common methods are E-mail, Cell-Text (or SMS) Messaging, Alpha-Numeric Pager, or Facsimile Transmittal. Then the Communication Engine 255 creates the notification(s) and distributes them to the single service provider who was initially selected by the consumer. One example of an e-mail notification is illustrated in FIG. 11G—see customer contact information 632B of the e-mail.

Additionally, at the time the service request is submitted, the Communications Engine 255 notifies the consumer in step 636 via e-mail confirming that the service request was received and providing the complete profile 210 in step 640 via e-mail of the home service provider that was selected by the consumer. Initially, the Communications Engine 255 querys the database 203 to determine the e-mail address included in the consumer's profile. Then the Communications Engine 255 distributes an e-mail message in step 636 to the consumer, designed to confirm that their service request is being processed and also to set their expectations regarding what will happen next. An example of this e-mail message is illustrated in FIG. 11H—see confirmation note 636B.

Additionally, the Communications Engine 255 distributes an e-mail message in step 640 to the consumer that provides the complete profile of the home service provider that was initially selected by the consumer. This e-mail message in step 640 (an example of this e-mail message is illustrated in FIG. 11I—see message 640B containing complete profile 210) may be presented in such a way that it appears to be sent from the single, selected service provider, by inserting the selected service provider's name into the “from” address on the message and by formatting the message text in such a way as to create the impression that the content of the e-mail was written by the selected service provider.

The Communications Engine 255 querys the database 203 to determine if the selected service provider desires this service or whether the selected service provider would prefer that the consumer receive the provider's complete profile in an e-mail message that is created and sent directly from the matching system 200.

Referring now to FIG. 6B, this figure illustrates additional steps in the process in which a consumer submits a home service request using the telephone-based method of contact. When the call transfer process is initiated in step 628 of FIG. 6A, the system 200 in step 656 retrieves the preferred phone number of the service provider selected by the consumer from the database 203, and then initiates a telephone call to the consumer selected home service provider.

When the call is connected, the system 200 plays an automated message in step 660 to provide context to the service provider receiving the call, by accessing data from the database 203. For example, the message could say “This is an Exact Match lead from ServiceMagic. The customer name is <insert customer name>. The project type is <insert type of work requested>. The location of the project is <insert city name that corresponds with ZIP code or service request>.” The system provides the ability for the consumer selected service provider to “accept” the phone call in decision step 664 by pressing a number on a dial pad. If this number is pressed, then the phone call can be connected in step 668 and the consumer and service provider are able to discuss the consumer's service request. If this number is not pressed, then the system 200 immediately calls the selected service provider's preferred phone number again in step 672.

This second attempt differs from the first call attempt in that once the call is answered after decision step 676, whether by the selected service provider or an answering machine or voice-mail, the consumer is connected immediately in step 680 to the service provider, thereby allowing the consumer to leave a voice message for the selected service provider on the home service provider's phone system. If the inquiry to decision step 676 is negative meaning that the call cannot be connected for any reason (for example, a busy tone), the call is routed back to the same CSR that originally spoke with the consumer in step 684 such that the CSR can provide the consumer with the selected service provider's actual phone number so that the consumer can connect with the selected service provider on their own schedule.

With the service request information captured from the consumer and entered into the database 203 via the CSR user interface 235, the matching engine 225 of the system 200 is able to determine whether the consumer selected service provider should be notified of the consumer's service need. It is possible that the consumer may provide information which will lead to a service need for which the service provider is not profiled. Such as in the scenario in which the queries to decision steps 616 and 620 of FIG. 6A are negative. For example, a consumer may access a service provider's profile seeking the services of a painting professional. The consumer's service need may require an interior painter, but the provider profile may indicate that the provider exclusively does exterior painting.

When this situation occurs, meaning that the inquiry to decision step 620 is negative, the CSR user interface 235 displays a message in step 644 indicating that the selected service provider is unable to complete the work requested via service request, but that the consumer may choose to request service from other service providers that are able to complete the work requested via the service request. An example of a message being presented to indicate that the selected service provider is unable to complete the consumer service request is illustrated in FIG. 11J—see message 644B). If the consumer chooses to request service from other service providers meaning that the decision to step 648 of FIG. 6A is positive, then the (CSR) initiates a secondary market match process that is fully illustrated in FIG. 8 and further described below. The CSR user interface 235 displays the forms in step 652 to enable the CSR to extract the additional data elements from the consumer to submit a secondary market match request 652.

In this situation, there are additional questions presented that allow a consumer to describe their service need in more detail before submitting the secondary market match service request that is more fully described in connection with FIG. 8 below. Examples of the presentation of these questions are found in FIGS. 653, 654, and 655. See first questions 652B, second questions 652C, and submit request button 652D.

In the situation in which the selected service provider is notified of the consumer's service request such as after steps 632 and 640 of FIG. 6A, then at a pre-determined time after the consumer service request is submitted and matched with service providers, the consumer will receive a request for Ratings & Reviews in step 688. This request is commonly made via the creation and distribution of an e-mail communication designed to capture the service provider's performance according to certain criteria established by the matching system 200. Alternatively, this request may be made by a CSR contacting the consumer using a telephone and then interacting with the CSR user interface to enter the rating information into the database. If the consumer chooses to provide the rating information in step 692, then this rating information is stored in the database 203 and may be presented as part of the service provider's profile 210 as it is presented to other consumers.

Process for On-line Exact Match Service Request

Referring now to FIG. 7, this figure illustrates further details of steps 430, 440, 450, and 460 of FIG. 4 in which a consumer submits an exact match service request using the consumer user interface 240, which is an on-line process comprising a series of web pages. Initially, as part of the service provider's profile, a consumer is presented with various data elements gathered from the database 203 that describe the service provider's business, including a list of the categories of service that are included in the selected service provider's profile. The consumer can initiate the on-line service request process by selecting one of the categories that are presented, or the consumer may select a website link in step 703 of FIG. 7 indicating the starting point for “requesting service on-line” from a single home service provider.

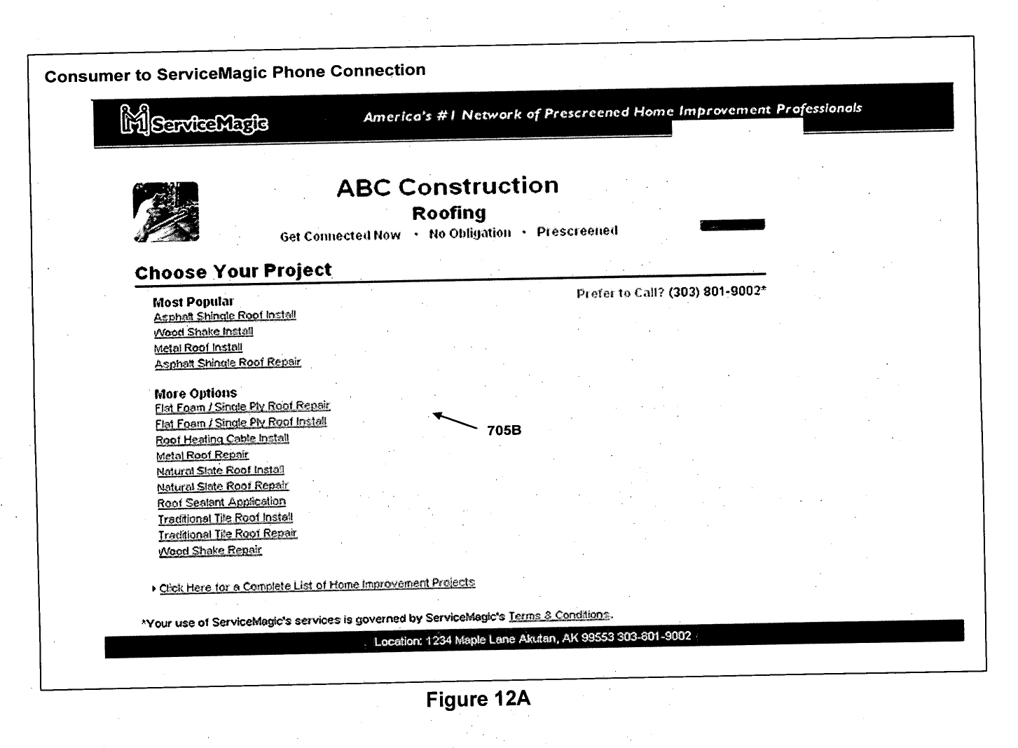

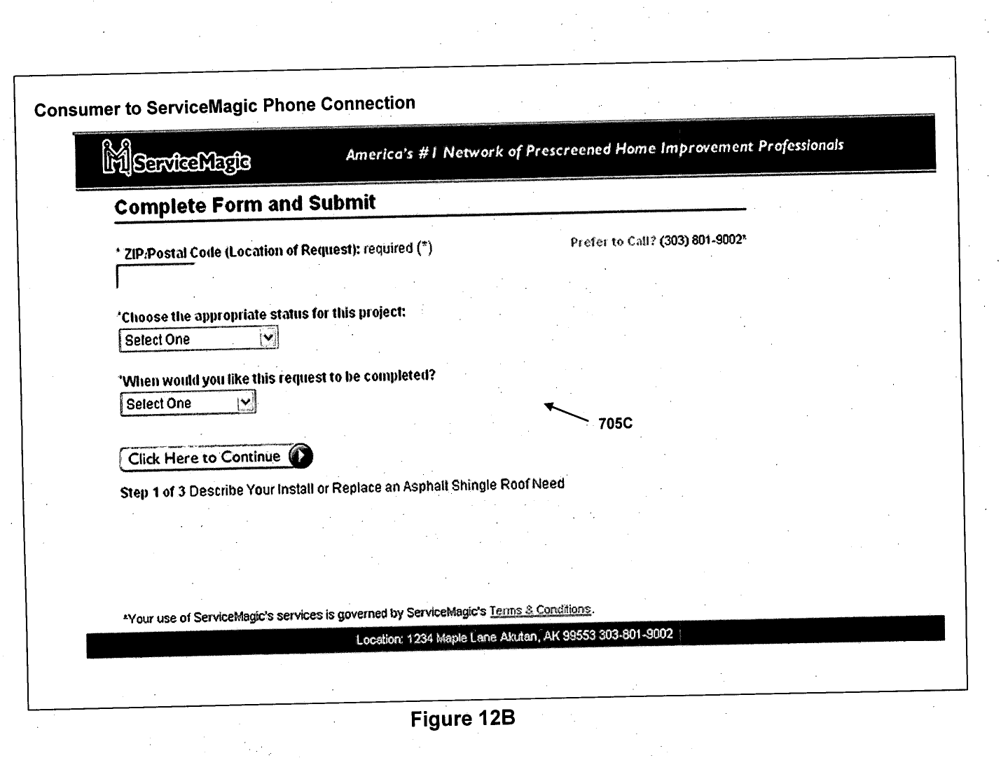

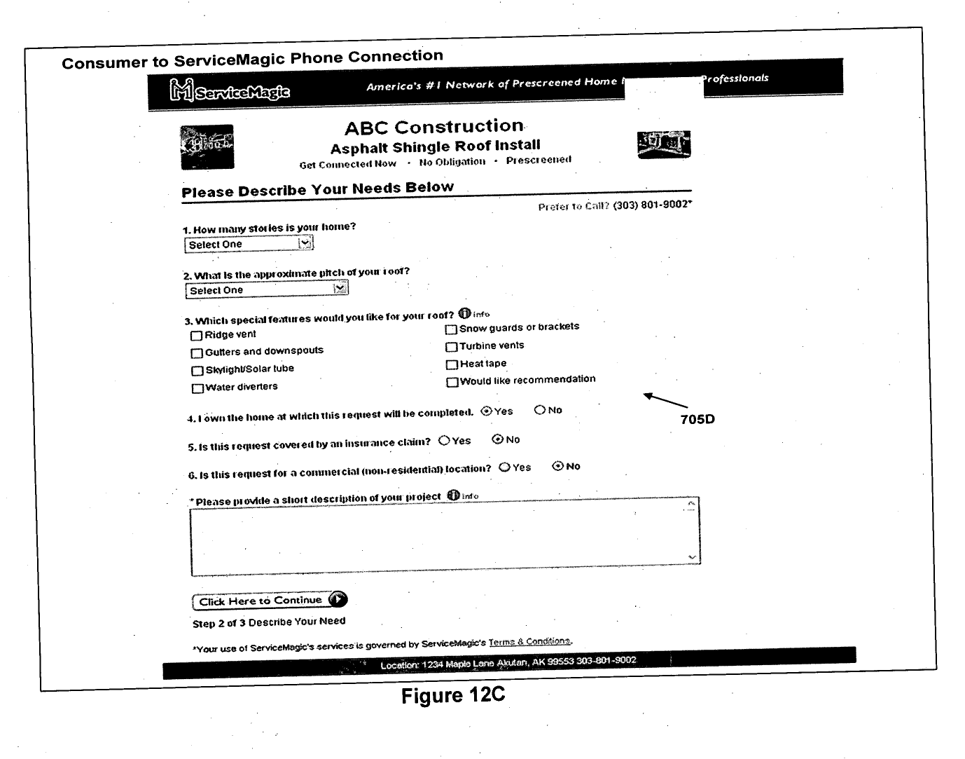

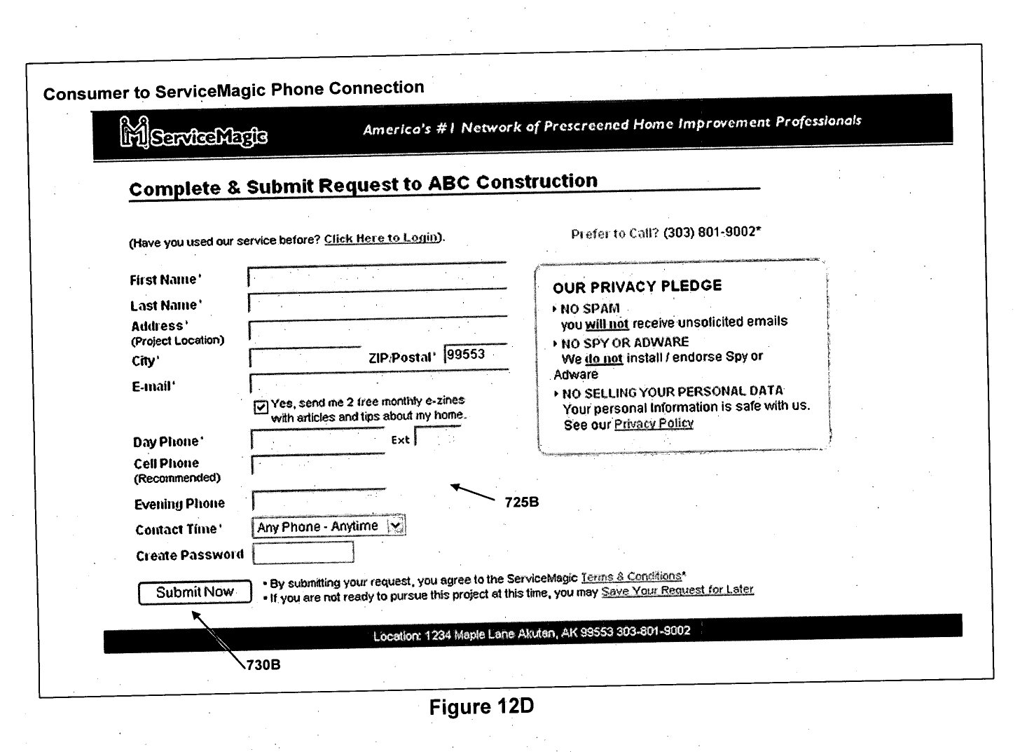

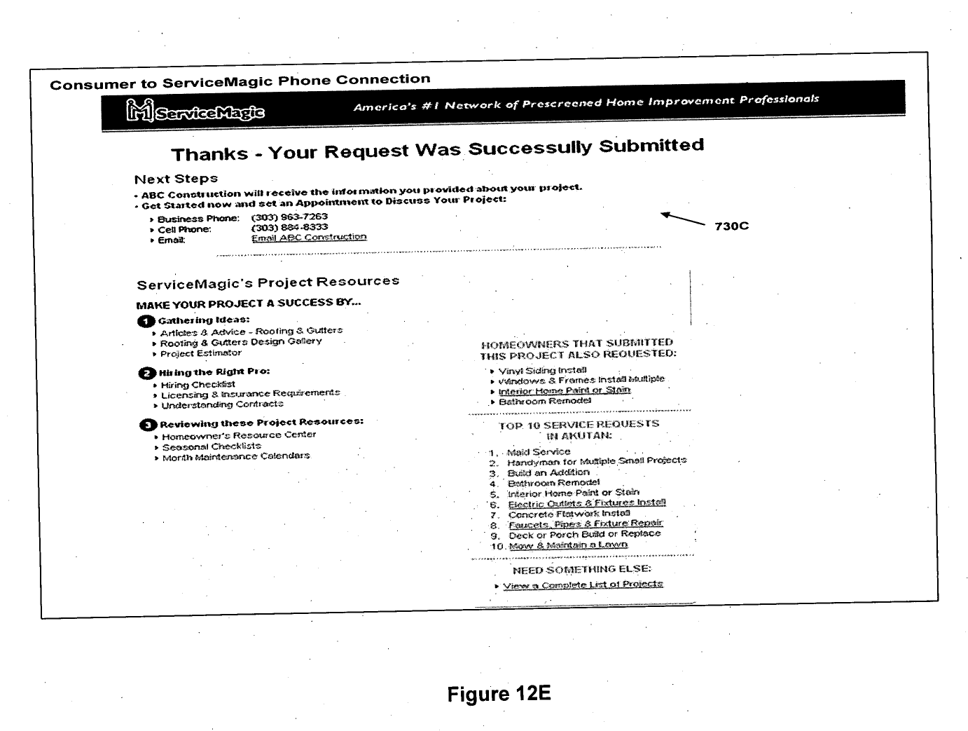

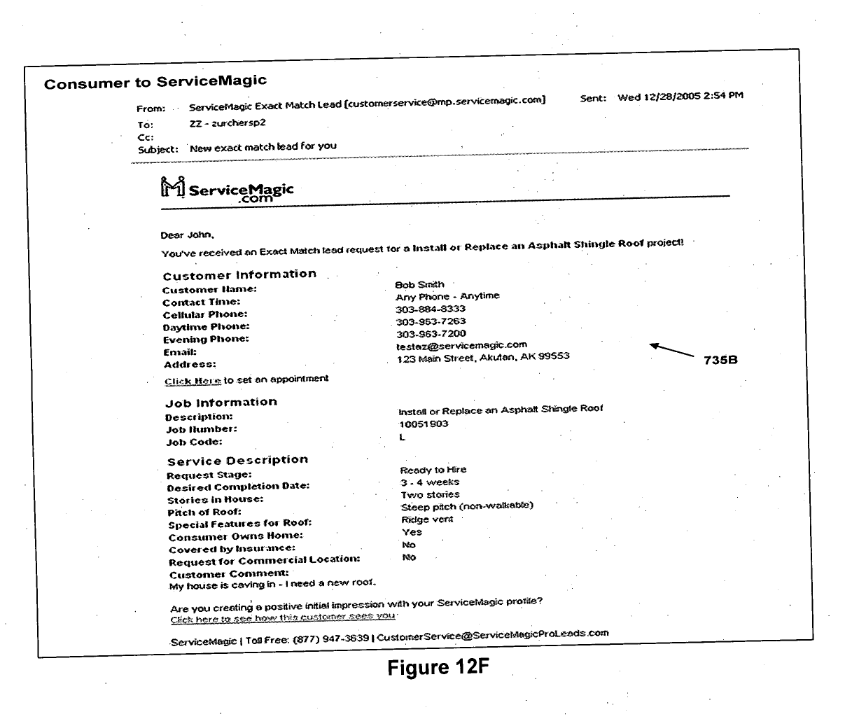

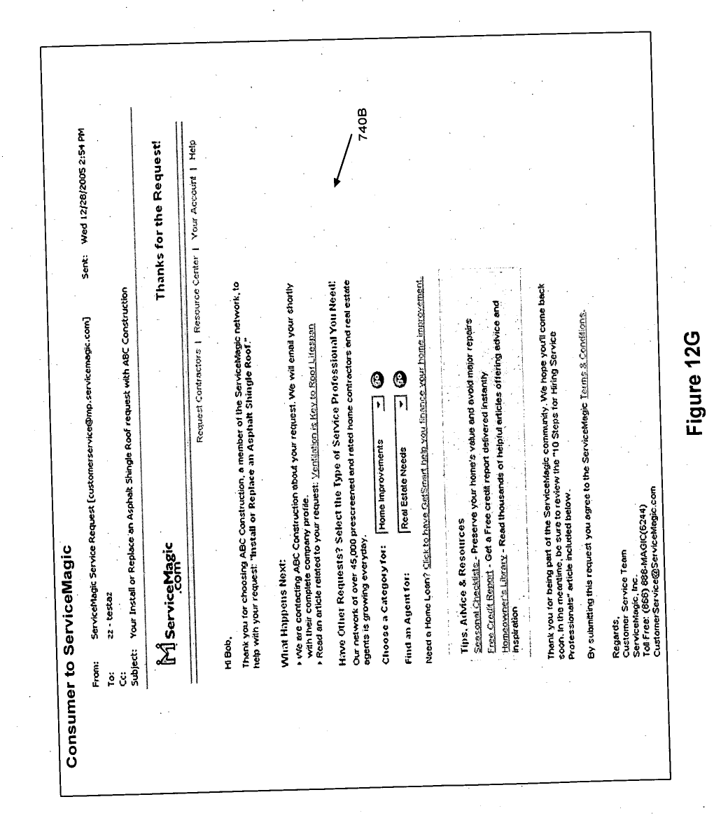

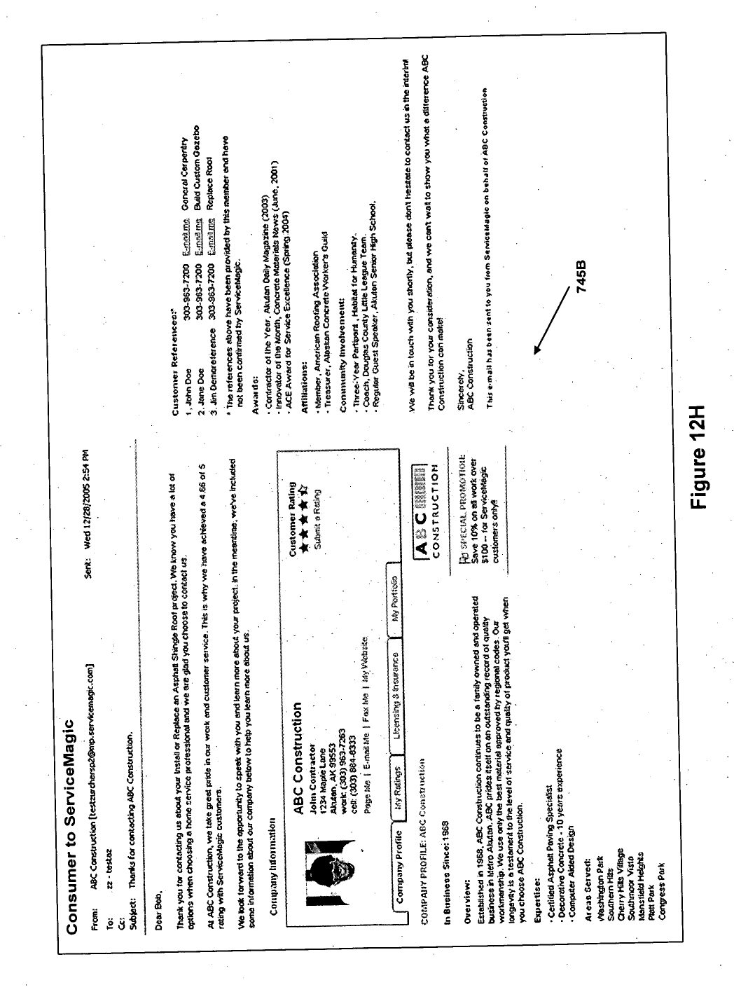

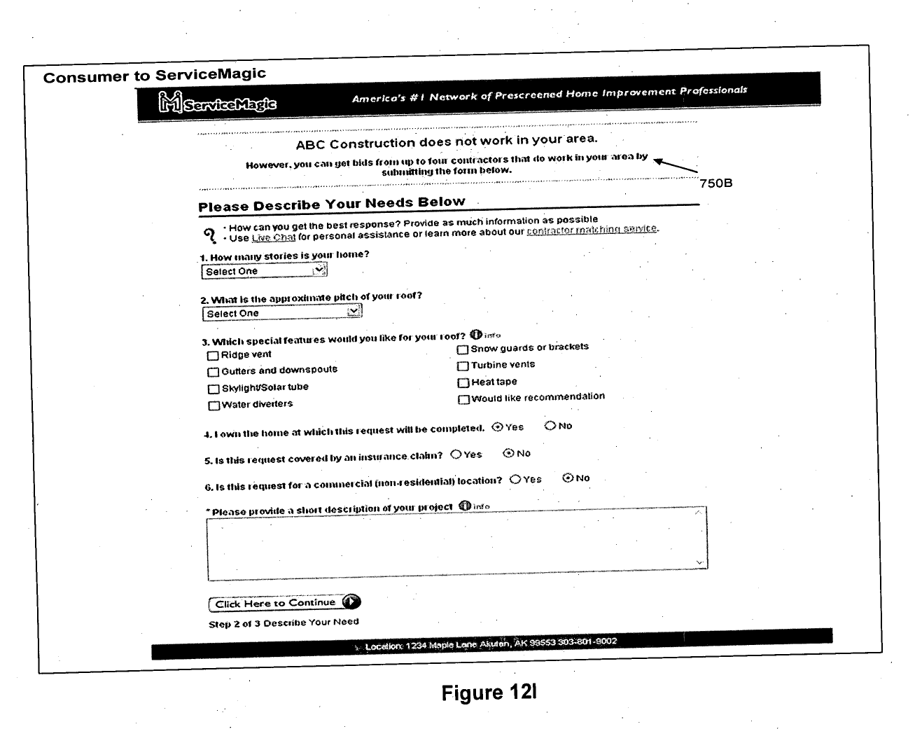

Through the on-line service request process (See examples of web pages illustrated in FIGS. 12A, 12B, 12C, and 12D), the system 200 extracts certain necessary data elements to ascertain whether the single, consumer selected service provider is a match for the consumer's specific need. The consumer is required to specify his or her home service need in step 705 by making selections and entering information into forms presented on the website. This information may include factors like the type of work requested and the location of the work to be completed. To complete the service request process, the consumer user interface 240 also displays a web page designed to capture the contact information from the consumer.

The information is compared by the inventive matching system 200 against the data contained in the database 203 to determine if the database 203 already contains a profile for the consumer submitting the current request. If the data elements are found in the database, the consumer user interface 240 provides the ability for the consumer to login to the website so they can use the account that already exists in the database 203.

If the consumer successfully logs in, then the account information that displays on the consumer user interface is populated with the contact information stored in the database. If the database does not contain a profile for the consumer submitting the current service request, then a new account is created by extracting certain information from the consumer. The consumer user interface 240 displays a web link to enable the consumer to submit the service request 730.

With the service request information obtained from the consumer, the matching engine 225 in steps 710-720 is able to determine whether the single service provider chosen by the consumer on-line should be notified of the consumer's service need. Specifically, the matching engine 225 compares the ZIP code of the service request in step 720 and in step 715 the specific type of work in the service request with the data stored in the database for the selected service provider.

If the postal ZIP code of the service request is included in the single consumer-selected home service provider's profile, and the type of work in the service request is included in the selected service provider's profile, then the potential for a match between the consumer and the selected service provider exists. Additionally, the matching engine 225 in step 710 queries the database 203 to confirm that the status of the home service provider selected by the consumer is “approved”, that the service provider selected by the consumer is currently accepting leads, and that the home service provider chosen by the consumer has spend cap available.

These three elements of “approved”, “accepting leads”, and “spend cap” of decision step 710 are fully described above with respect to overview decision step 450 discussed above with respect to FIG. 4. If the three criteria of step 710, the criteria of step 715, and the criteria of step 720 are met, then the service request is considered an exact match between the consumer and the home service provider that was initially selected by the consumer and the process continues to step 725 in which all web forms and contact info are verified for completion.

At the time the exact match service request is submitted in step 730, the database 203 is updated to include the consumer's service request information 215. This information is associated with both the consumer account 205 within the database 203 and also with the selected service provider profile 210.

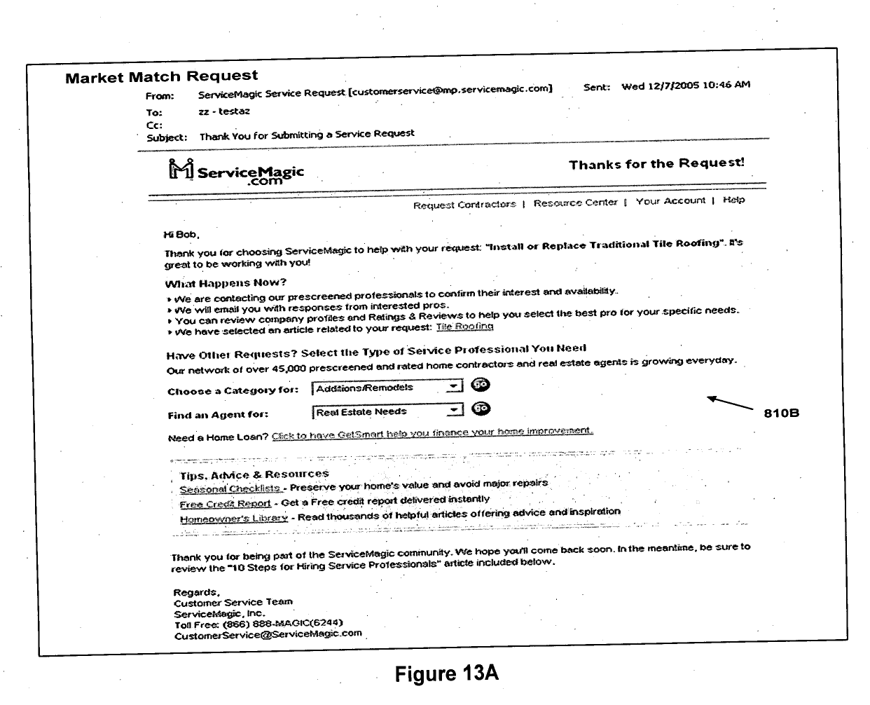

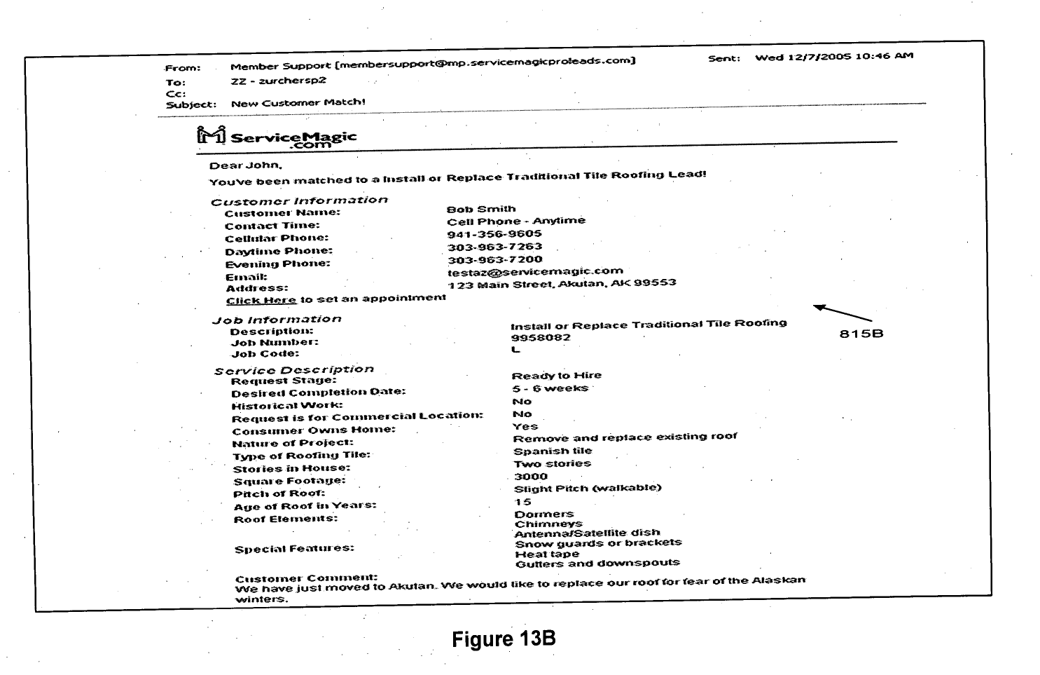

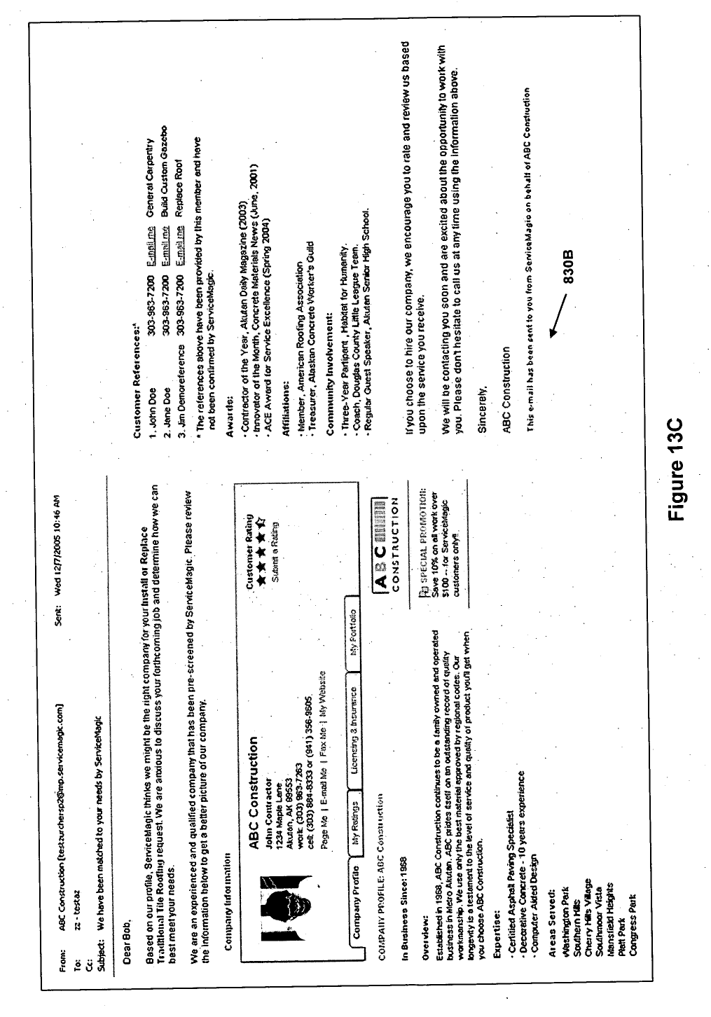

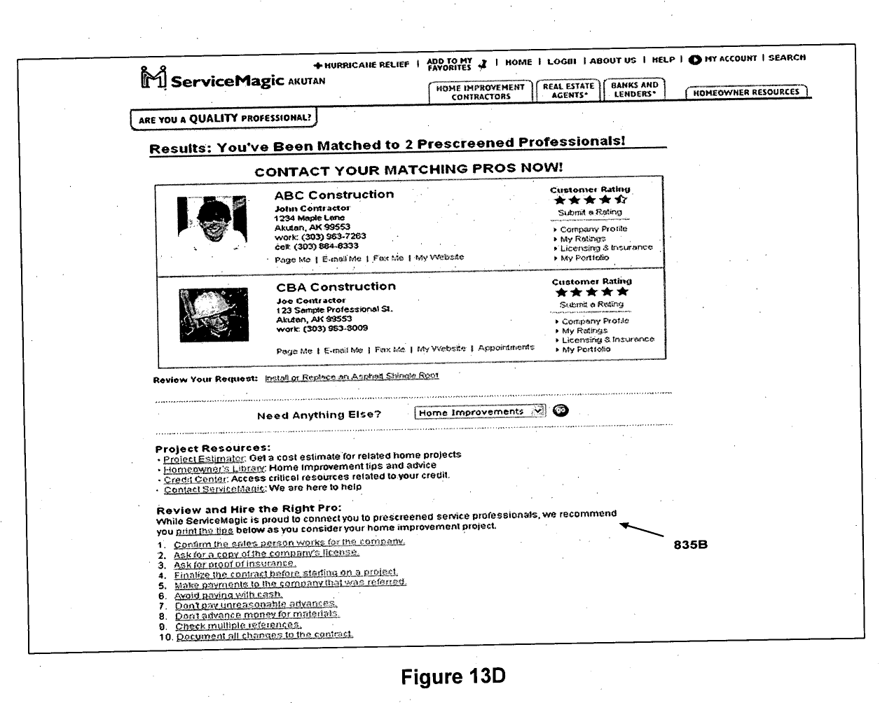

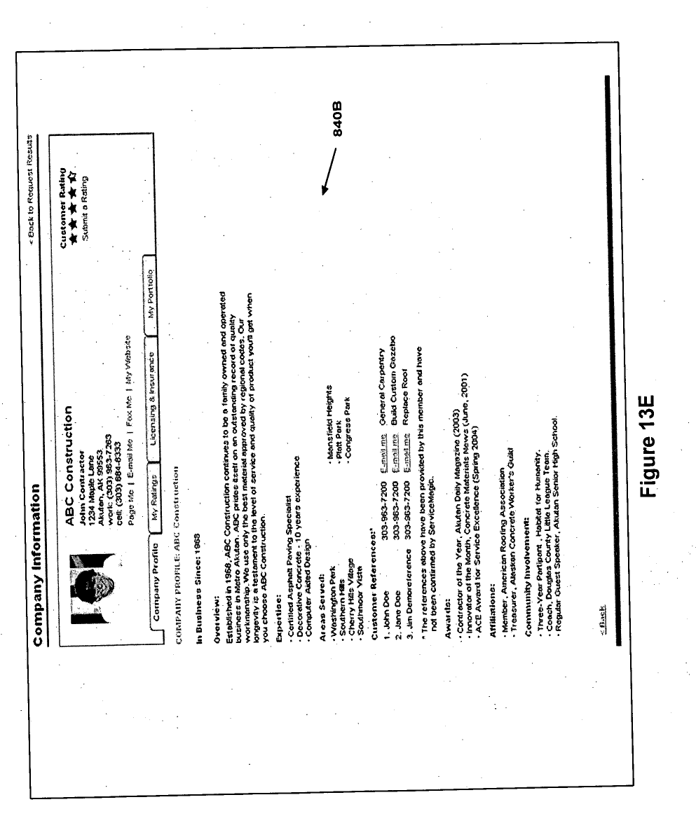

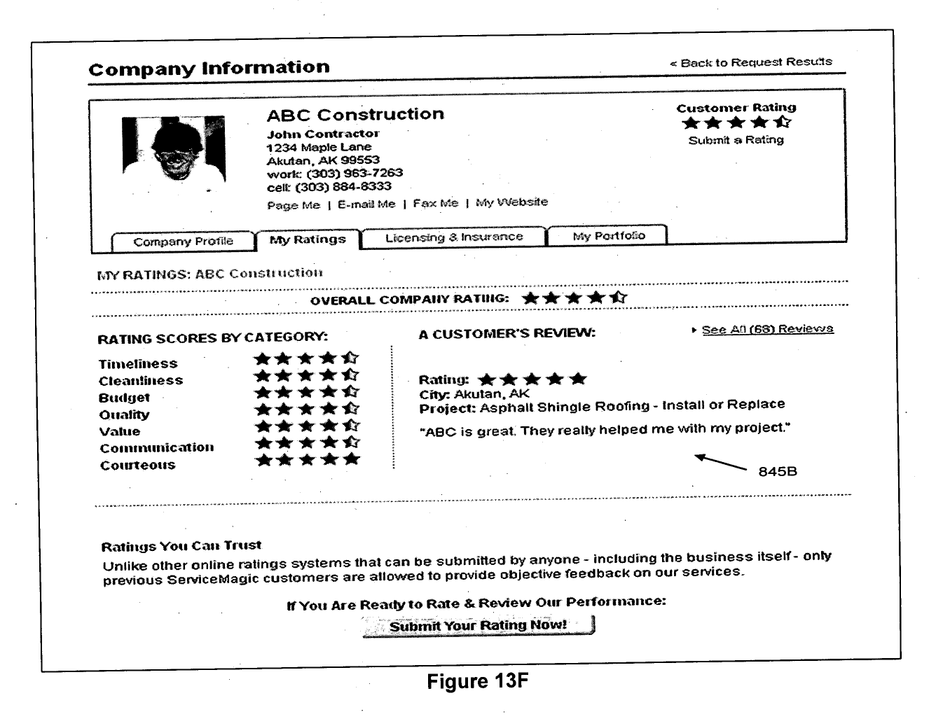

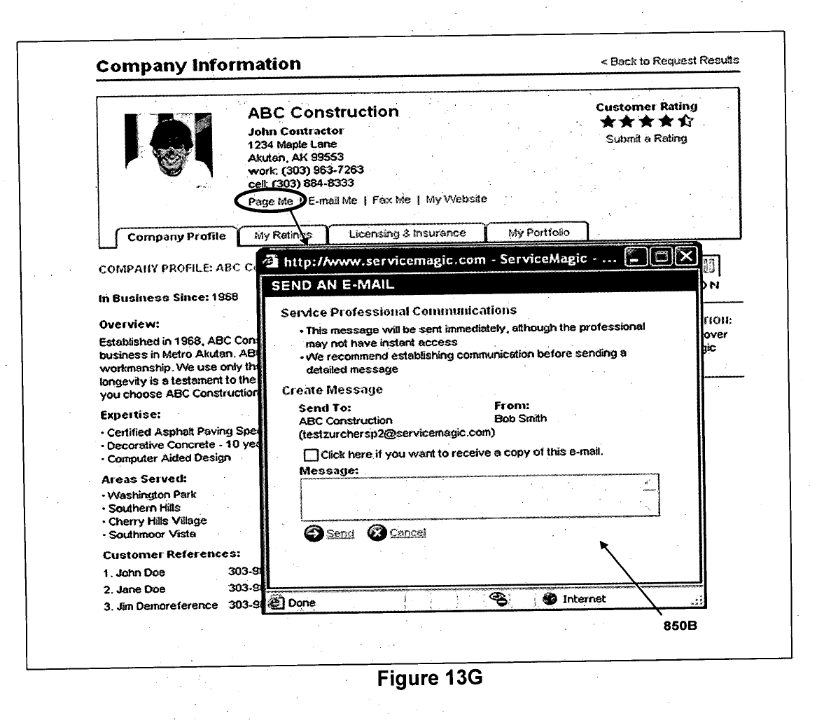

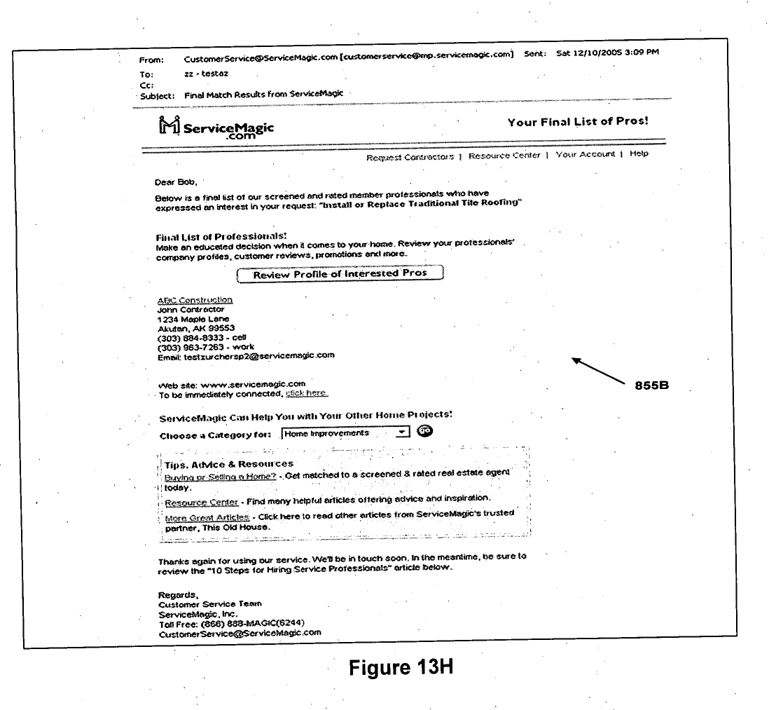

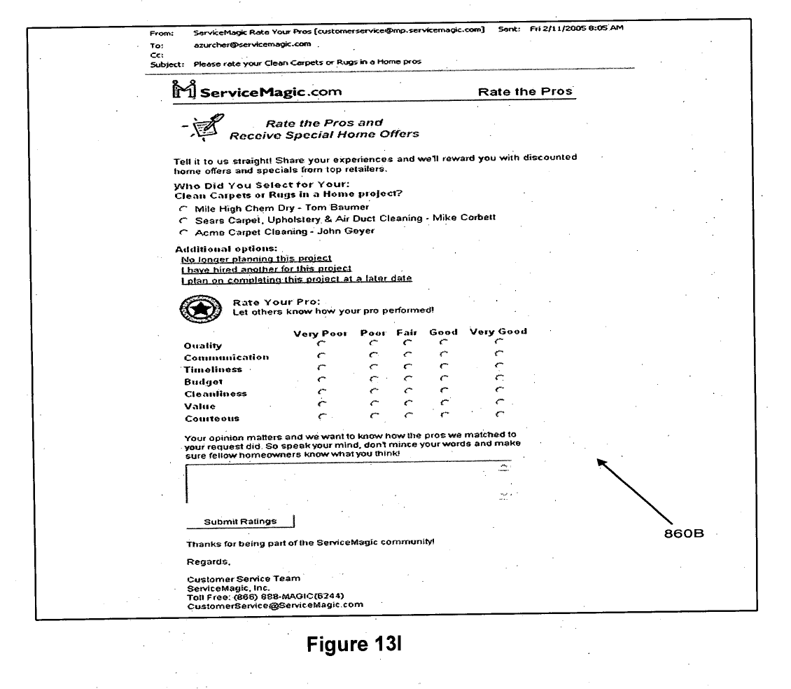

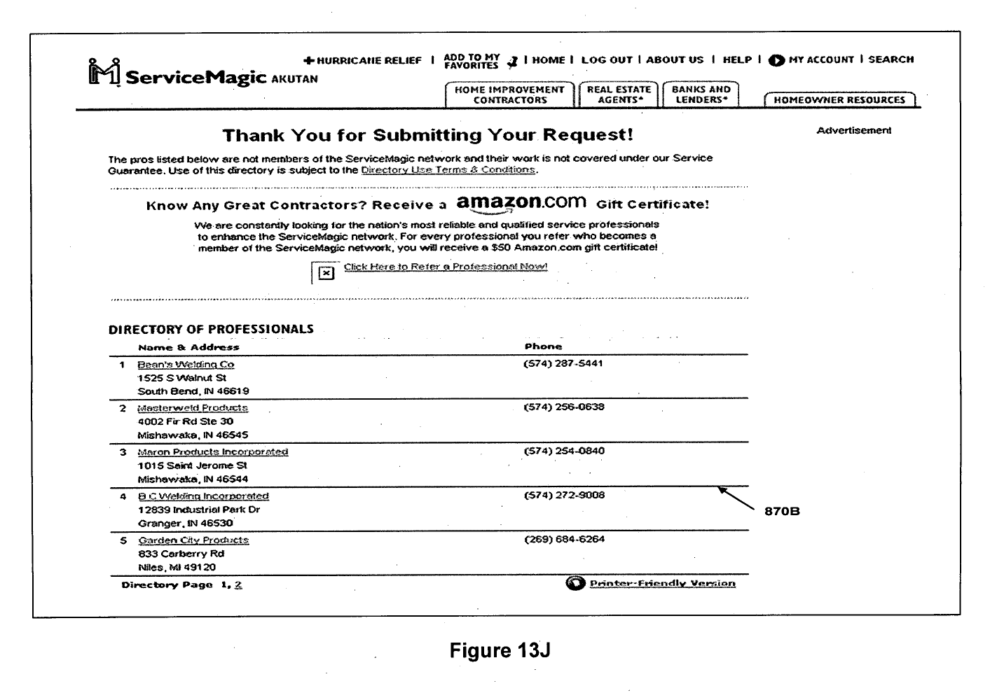

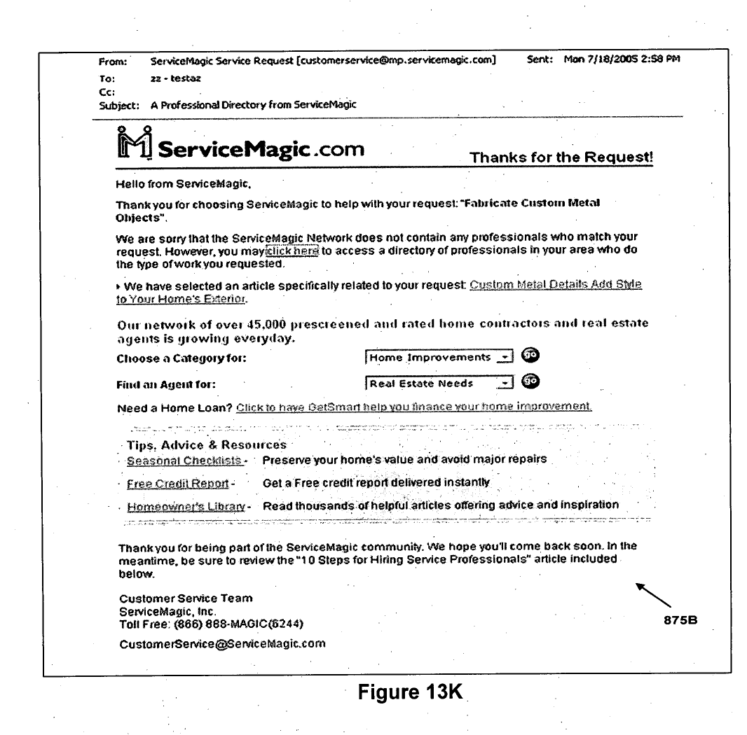

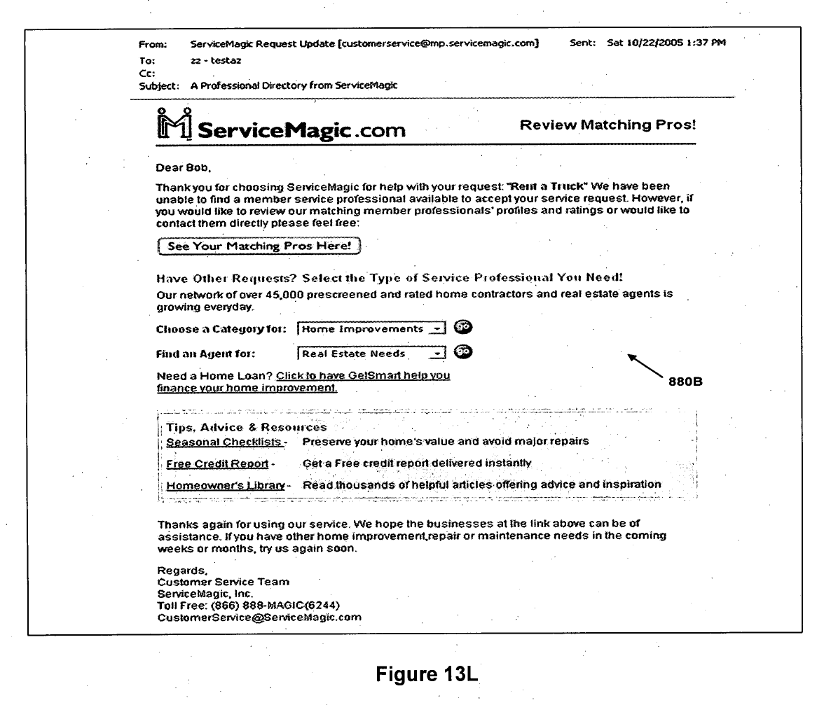

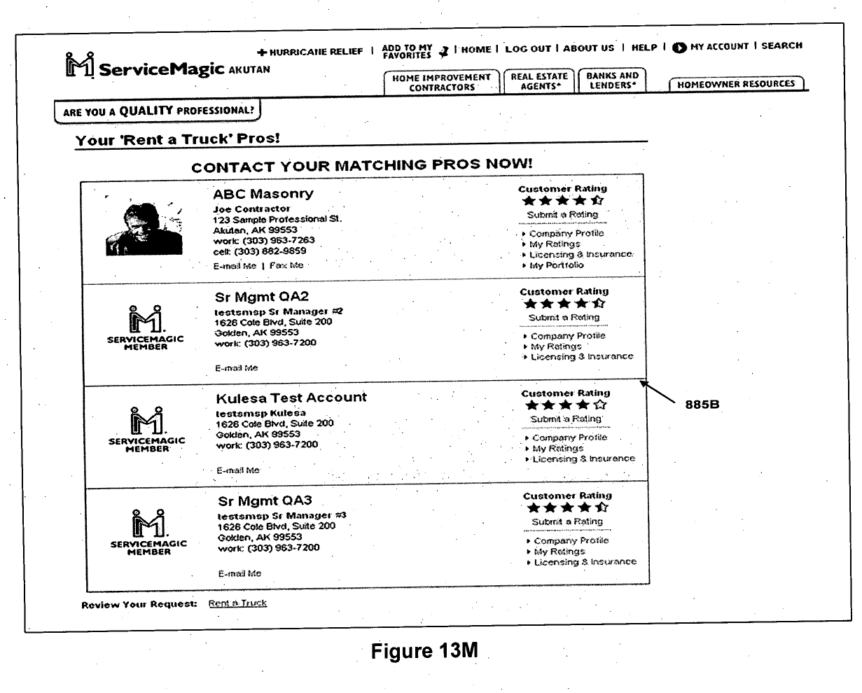

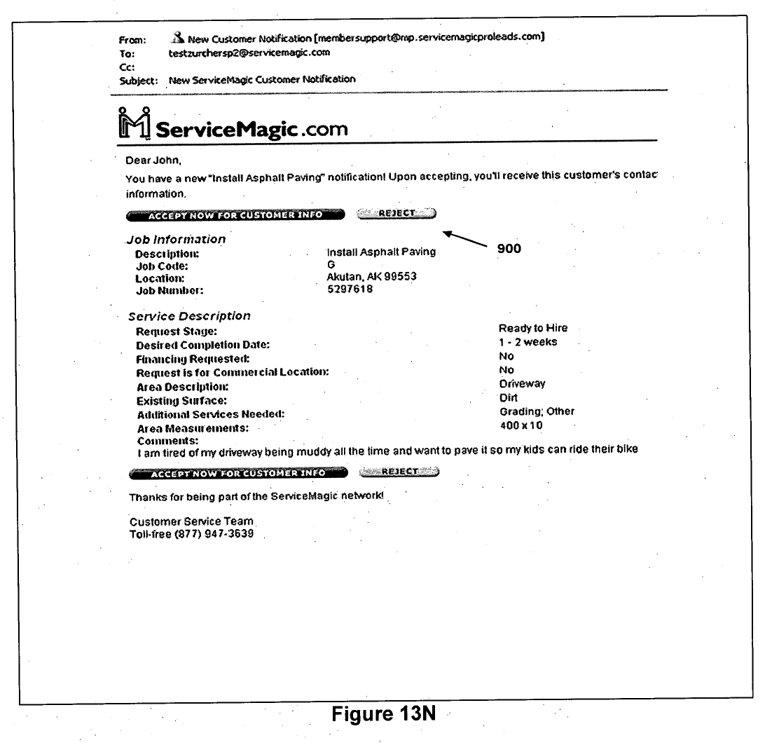

As a result, when the consumer and the selected service provider access their accounts, either by logging in to the website or by calling a CSR or other method, they are provided the information about all service requests that have been associated with their accounts. Additionally, the consumers have access to the profile information of the service providers (see FIG. 13E) to whom their requests have been matched and the service providers have access to the profile information of the consumers who have submitted service requests that have been matched to them.

Also, at the time the exact match service request is submitted in step 730, the Communications Engine 255 notifies the service provider selected by the consumer of the new consumer in step 735. Initially, the Communications Engine 255 querys the database 203 to determine which methods of communication are included in the selected service provider's profile. The most common methods are E-mail, Cell-Text (or SMS) Messaging, Alpha-Numeric Pager, or Facsimile Transmittal. Then the Communication Engine 255 creates the notification(s) and distributes them to the selected service provider in step 735. An example of an e-mail notification for step 735 is illustrated in FIG. 12F—see consumer contact information 735B.

Additionally, at the time the exact match service request is submitted in step 730, the Communications Engine 255 notifies the consumer in step 740 confirming that the service request was received and providing the complete profile of the home service provider that was initially selected by the consumer. Usually, the Communications Engine 255 first queries the database 203 to determine the e-mail address included in the consumer's profile. Then the Communications Engine 255 distributes an e-mail message in step 740 to the consumer, designed to confirm that their service request is being processed and also to set their expectations regarding what will happen next. See e-mail message illustrated in FIG. 12G—expectations message 740B. Additionally, the Communications Engine 255 distributes an e-mail message in step 745 to the consumer that provides the complete profile of the selected service provider.

This e-mail message of step 745 may be presented in such a way that it appears to be sent from the service provider that was initially chosen by the consumer, through inserting the selected service provider's name into the “from” address on the message and by formatting the message text in such a way as to create the impression that the content of the e-mail was written by the selected service provider. See FIG. 12H—personalized message 745B for an example of an e-mail message may be presented in such a way that it appears to be sent from the selected service provider.

The Communications Engine 255 querys the database 203 to determine if the home service provider selected by the consumer desires this type of presentation or whether the selected service provider would prefer that the consumer to receive the provider's complete profile in an e-mail message that is created and sent directly from the inventive matching system 200 with an identity of the matching system 200.

With the service request information captured from the consumer, the matching engine 225 in steps 710-720 is able to determine whether the single home service provider selected by the consumer should be notified of the consumer's service need. It is possible that the consumer may provide information which will lead to a service need for which the service provider is not profiled such as a negative inquiry to decision step 715 of FIG. 7. For example, a consumer may access a service provider's profile seeking the services of a painting professional.

The consumer's service need may require an interior painter, but the provider profile may indicate that the home service provider exclusively does exterior painting. When this situation occurs, the consumer user interface 240 displays a message indicating that the home service provider chosen by the consumer is unable to complete the work requested via service request (See FIG. 752 for example—unable to service message 750B), but that the consumer may choose to request service from other service providers that are able to complete the work requested via the service request in step 750.

If the consumer chooses to request service from other service providers in decision step 755 by completing the service request process to submit the request to other service providers, then the system initiates the secondary market match process that is further described below in connection with FIG. 8.

In the situation in which the home service provider chosen by the consumer is notified of the consumer's service request, then at a pre-determined time after the consumer service request is submitted and matched with a service provider, the consumer will receive a request for Ratings & Reviews in step 760. This ratings request is commonly made via the creation and distribution of an e-mail communication designed to capture the service provider's performance according to certain criteria established by the inventive matching system 200. Alternatively, this request may be made by a CSR contacting the consumer using a telephone and then interacting with the CSR user interface 235 to enter the rating information into the database 203. If the consumer chooses to provide rating information in step 765, this rating information is stored in the database 203 and may be presented as part of the service provider's profile as it is presented to other consumers.

Secondary Process for Market Match Service Request

Referring now to FIG. 8, this figure illustrates a logical flow chart diagram for a secondary market matching process 800, after it has been determined by the inventive matching system 200 by executing the primary “exact” matching process that a single service provider selected by a consumer is not able to meet the service need(s) of the consumer.

According to one exemplary embodiment, as noted in the description of FIG. 7 above, at step 755, or as noted in the description of FIG. 6A above at step 652, a consumer must indicate at step 801 with a click of a web link using the on-line exact match process of FIG. 7 or by providing additional service request information and a verbal confirmation to a CSR using the phone-based exact match process of FIG. 6A, that he or she would like to be matched to other service providers not initially selected or known to the consumer who may be able to meet the consumer's service need. Once the consumer's intention is indicated in step 801, the matching engine 225 of the inventive system 200 in decision routine 805 can prepare a list of service providers who may be able to meet the service need(s) of the consumer. Further details of decision routine 805 will be described below in connection with FIG. 8B.

If the matching engine 225 determines after decision routine 805 that there are no service providers in the database 203 that meet the criteria for a matching service request, then in step 870 the consumer is provided with a directory or list of service providers that are NOT members of the pre-screened provider network as maintained in the database 203. An example of a web page that lists service providers who are not members of the database 203 is illustrated in FIG. 13J—see directory of professionals 870B. This directory or list of non-member providers may be acquired by the inventive matching system 200 from a third party and stored in a separate table within the database 203, or it may be maintained by a third party separate from the inventive matching system 200 such as third party database, like CitySearch, that allows the web servers 230 of the matching system 200 to retrieve a directory or list of service providers for purposes of displaying certain elements of non-member service provider profiles to the consumer who has submitted a service request.

This directory or list of non-member service providers can be delivered via the consumer user interface 240 such as a web page. Additionally, the directory or list of non-member service providers can be delivered via verbal communication from a CSR to the consumer if the consumer is interacting with the system by speaking with a CSR on a telephone.

Regardless of how the directory list of non-member professionals is delivered to the consumer, the consumer will receive communication that his or her request was received and that the result of their request is a directory of non-member professionals. According to one exemplary embodiment, a consumer is provided access to that directory or list in step 875 typically by a web link in an e-mail message. For example, see FIG. 13K that illustrates such an e-mail message 875B. To generate this e-mail message, the Communications Engine 255 queries the database 203 to locate the e-mail address that is included in the consumer's profile.

If the matching engine 225 determines after decision routine 805 that there are one or more service providers in the database 203 that meet the criteria for a matching service request, then the Communications Engine 255 notifies the consumer via e-mail in step 810, confirming that his or her service request is being processed and also setting their expectations regarding what will happen next. See FIG. 13A for an e-mail message that notifies a consumer that matched service providers will be contacted—see expectations message 810B. To notify the consumer via e-mail, the Communications Engine 255 queries database 203 to determine the e-mail address that is included in the consumer's profile.

Simultaneously, or subsequently, the Notification Engine 255 of the matching system 200 in step 815 begins notifying the list of service providers that met the criteria in decision routine 805 of the service request. The Communications Engine 255 queries the database 203 to determine which methods of communication are included in the matching service provider profiles. The available methods for service providers are typically E-mail, Cell-Text (or SMS) Messaging, Alpha-Numeric Pager, Facsimile Transmittal, or Automated Telephone Call. This means that in step 815, the Communication Engine 255 uses the appropriate communication(s) method(s), as indicated in preferences of each service provider's profile, and distributes the service request to the service providers who matched the service request in decision routine 805. See FIG. 13B as an example e-mail notification to a service provider enrolled in the premier pro program—see consumer contact information 815B.

The notification distributed in step 815 to a market matched service provider not initially known or selected by a consumer will include the consumer's contact information (name, phone number, physical address or e-mail address), in addition to the consumer's description of their service need, if the service provider is enrolled in an optional program that is referred to generally as a “Premier Professional” program.

The Premier Professional program is an optional service of the matching system 200 in which a service provider can automatically accepts leads that match the criteria he or she has established in his or her profile, as stored in the database 203. If a service provider is not enrolled in the Premier Professional program, and instead is enrolled in the Lead Select program, then the notification sent in step 815 does not include the consumer's contact information. The Lead Select program is an optional service of the matching system 200 in which a service provider accepts leads only after reviewing the consumer's description of his or her service need. The email notifications sent to Lead Select providers do not include the contact information of the consumer making the request. Rather these email notifications include the consumer's description of his or her service need, in addition to a web link that a provider can click to indicate their intent to accept the lead. See FIG. 13N as an example email notification to a service provider enrolled in the Lead Select program.

In decision step 817, the matching engine 225 determines if a market matched service provider is enrolled in the Premier Professional program. If the inquiry to decision step 817 is negative, the “No” branch is followed to decision step 820. If the inquiry to decision step 817 is positive, then the “Yes” branch is followed to step 819. In step 819, the consumer lead is automatically selected by the market matched service provider if the market matched service provider has a sufficient spending cap. It is noted that two different spending caps may exist for any single service provider: a first spending cap for the primary or “exact” match process of FIGS. 6-7 and a second spending cap for the premier pro program of the secondary market match process of FIG. 8.

In decision step 820, the service provider can accept a consumer lead by any one of the following: 1) click on a web link from the e-mail notification to indicate their intention to accept the lead opportunity, 2) call the automated phone system 265 to indicate their intention to accept the lead opportunity by voicing their intention or pressing touch-tone buttons based on a menu of options, or 3) call a CSR who works with the CSR user interface 235 to act on behalf of the service provider and indicate the service provider's intention to accept the lead opportunity. Once a Lead Select provider accepts the lead, then the communications engine will send an additional notification (in step 825) to the provider which provides the customer's contact information. See FIG. 13N as an example email that contains the consumer's contact information, sent to a service provider enrolled in the Lead Select program after they have accepted the lead.

After a pre-determined amount of time has passed without lead acceptance or if a matched service provider expressly declines a consumer lead (or both), the inquiry to decision step 820 is deemed as negative, and the “No” branch is followed to step 880. In step 880, the consumer will be notified that the matching system 200 was unable to find a service provider who accepted the consumer's service need. See FIG. 13L for an e-mail communication notifying a consumer that the system 200 was unable to identify a service provider who is able to meet the consumer's service need—see no-match message 880B. In step 885, the consumer can be provided with the contact information of a predetermined number of service providers whose profiles matched the consumer's service request, but who did not accept the lead opportunity.

According to one exemplary embodiment, the predetermined number of service providers who did not accept the consumer lead and who are identified to the consumer can be four. However, fewer or more service providers can be identified to the consumer without departing from the scope and spirit of the invention. This notification of one or more home service providers can be distributed to the consumer via e-mail, and may contain a web link to the web site, where the complete profile of the market matched service providers who did not accept the consumer's service need is displayed. An example of a web site providing a consumer with a predetermined number of service providers whose profiles matched the consumer's service request, but who did not accept the lead opportunity is illustrated in FIG. 13M—see Listing of Non-accepting service providers 885B.

If the inquiry to decision step 820 is positive meaning that a service provider has expressly accepted a consumer lead, then in step 825 each accepting service provider receives the consumer contact information that may comprise name, e-mail address, physical address of the project location, one or more telephone number(s), and designation of which of the telephone numbers is preferred. An example of consumer contact information is illustrated in FIG. 817—see element 825B. All of the contact information can be maintained as part of the consumer's profile and is stored in the database 203.

In step 830, the complete profile of each accepting service provider can be displayed on a web site for a consumer to review. For example, see FIG. 13D. Additionally, the complete profile of each service provider can be distributed to the consumer via e-mail. For an example of a service provider profile distributed by e-mail, see FIG. 13C—message 830B. This e-mail message includes data stored as part of the service provider's profile 210, allowing the consumer to review information about the provider and presenting contact information that can allow the consumer to contact the service provider directly. Within the e-mail message are web links that enable the consumer to access additional profile information within the service provider's profile as presented on web sites hosted by the inventive matching system 200.

In step 835, after a consumer navigates to the web site provided in the e-mail notification in step 830, a listing of each market matched and accepted service provider can be displayed on the web site. In step 840, each market matched and accepted service provider's complete profile information can also be displayed on the web site. For example, see FIG. 13E.

In step 845, the ratings & reviews that previous consumer members have provided about the service provider can also be displayed. For example, see FIG. 13F. In step 850, the consumer can also be provided access to a communications platform by viewing the contact preferences of each market matched and accepted service provider with the ability to create and send e-mail messages to the professional from the web site hosted by the matching system 200. For example, see FIG. 13G that illustrates a e-mail that can be generated with the communications platform.

At consumer lead expiration step 855 that occurs after a maximum predetermined number of service providers who have accepted the consumer lead opportunity or after a pre-determined amount of time passing without the service request receiving the maximum predetermined number of lead acceptances from service providers, the consumer receives an e-mail presenting the service providers who accepted the lead opportunity. For example, see FIG. 13H. According to one exemplary embodiment, the maximum predetermined number of lead acceptances from service providers can be four. However, fewer or more lead acceptances from service providers can be used without departing from the scope and spirit of the invention. The e-mail message sent in step 855 can contain a list of the service providers as well as a web link that enables the consumer to access the profile information on a web site hosted by the matching system 200 of all of the service providers who accepted the lead opportunity.

At a predetermined amount of time after the consumer service request is submitted and matched with service providers, in step 860 the consumer may receive a request for Ratings & Reviews from the matching system 200. This request is commonly made by distributing an e-mail communication created by the matching system 200 and designed to identify which service provider was selected by a consumer to fulfill the consumer's service need. The e-mail can also be designed to measure how that service provider performed. For example, see FIG. 131. In step 865, the consumer can describe and rate the service provider's performance according to certain criteria established by the matching system 200. Alternatively, this request may be made by a CSR contacting the consumer using a telephone and then interacting with the CSR user interface 235 to enter the rating information into the database 203. If the consumer decides to provide the rating information, the information is stored in the database 203 and may be presented as part of the service provider's profile 210 as it is presented to other consumers.

Referring now to FIG. 8B, this figure illustrates a logic flow chart diagram for the steps of decision routine 805 of FIG. 8A according to one exemplary embodiment of the invention. Decision step 803 is the first step of decision routine 805. In decision step 803, the matching engine 225 compares the ZIP code of the service request and the specific type of work in the service request with the data stored in the database 203 for all service providers in the database 203. This step is similar to decision step 620 of FIG. 6A described above but it is different in that multiple service providers are compared to the consumer service request instead of one or a single home service provider examined in the process of FIG. 6.

If the ZIP code of the service request is included in any of the service provider's profiles, and the type of work in the service request is also included in those service provider's profiles, then the potential for a match between the consumer and one or more members of the service provider network may exist and the process continues to step 806. If the inquiry to decision step 803 is negative, the “No” branch is followed and the process returns to the “No” branch decision flowing from decision routine 805 in FIG. 8A to Step 870.

If the inquiry to decision step 803 is positive, then the “Yes” branch is followed to step 806. In step 806, the matching engine 225 queries the database 203 to confirm that the status of any matching service providers is “approved” and that they are currently accepting leads. Step 806 is similar to step 616 of FIG. 6A, however, step 806 does not have a “spend cap” determination that is made in step 616 and multiple service providers are examined instead of one as in the case of FIG. 6.

If the two criteria of decision step 806 are met, then the service request is considered a matched service request and a list of matching service providers is created and stored in the database 203. The process follows the “Yes” branch from decision step 806 and returns to the “Yes” branch flowing out of decision routine 805 of FIG. 8B. If the inquiry to decision step 806 is negative, then the “No” branch is followed and the process returns to the “No” branch flowing out of decision routine 805 to step 870.

Exemplary Computer Screen Displays

Referring now to FIG. 9A, this figure is an exemplary computer screen display illustrating a service provider profile according to one exemplary embodiment of the invention. A phone number 420B can be selected by a consumer to contact the selected service provider. Alternatively, a hypertext link 430B can be selected by a consumer to contact the selected service provider.

Referring now to FIG. 9B, this figure is an exemplary computer screen display illustrating a service provider profile with a ratings and review user interface according to an exemplary embodiment of the invention. Similar to FIG. 9A, a phone number 420B can be selected by a consumer to contact the selected service provider. Alternatively, a hypertext link 430B can be selected by a consumer to contact the selected service provider.

Referring now to FIG. 10A, this figure is an exemplary computer screen display illustrating a service provider profile distribution as an organic search result 550B according to an exemplary embodiment of the invention. This screen display also illustrates a pay-per-click (PPC) search listing 560B.

Referring now to FIG. 10B, this figure is an exemplary computer screen display illustrating a service provider profile distribution as a Internet Yellow Pages (IYP) listing according to an exemplary embodiment of the invention. This screen display illustrates a plurality of IYP search results 570B.

Referring now to FIG. 10C, this figure is an exemplary computer screen display illustrating a service provider profile distribution that is generated by the inventive matching system according to an exemplary embodiment of the invention. Specifically, this screen display illustrates a listing 580B of a plurality of home service providers profiles that can be generated by the inventive matching system.

Referring now to FIG. 11A, this figure is an exemplary computer screen display illustrating a customer service representative user interface according to an exemplary embodiment of the invention. This display screen illustrates a CSR user interface 235 that can be used to collect a zip code 612B from a consumer.

Referring now to FIG. 11B, this figure is another exemplary computer screen display illustrating a customer service representative user interface according to an exemplary embodiment of the invention. This display screen illustrates an example of a web page designed to capture a consumer's type 612C of home service or work desired.

Referring now to FIG. 11C, this figure is another exemplary computer screen display illustrating a customer service representative user interface according to an exemplary embodiment of the invention. This display screen illustrates an example of a web page designed to capture a consumer's contact information such as a daytime phone number 624B.

Referring now to FIG. 11D, this figure is another exemplary computer screen display illustrating a customer service representative user interface according to an exemplary embodiment of the invention. This display screen illustrates an example of a web page designed to capture a consumer's contact information such as an e-mail address 624C.

Referring now to FIG. 11E, this figure is another exemplary computer screen display illustrating a customer service representative user interface according to an exemplary embodiment of the invention. This display screen illustrates button 628B that allows a CSR to submit an exact match request after information about the consumer is displayed and can be verified by the CSR.

Referring now to FIG. 11F, this figure is another exemplary computer screen display illustrating a customer service representative user interface according to an exemplary embodiment of the invention. This display screen illustrates a transfer call button 628C that allows a CSR to transfer a consumer call to a home service provider.

Referring now to FIG. 11G, this figure is another exemplary computer screen display illustrating an e-mail notification sent to a service provider according to an exemplary embodiment of the invention. This display screen illustrates customer contact information 632 that can be contained in an e-mail notification to a home service provider.

Referring now to FIG. 11H, this figure is another exemplary computer screen display illustrating an e-mail notification sent to a consumer according to an exemplary embodiment of the invention. This display screen illustrates a consumer service request submission confirmation message 636B that can be contained in an e-mail notification sent to a consumer service provider.

Referring now to FIG. 11I, this figure is another exemplary computer screen display illustrating an e-mail notification sent to a consumer that appears to originate from the service provider according to an exemplary embodiment of the invention. This display screen illustrates an e-mail message sent in step 640 to the consumer that provides the complete profile of the home service provider that was initially selected by the consumer. This e-mail message 640B can contain a complete profile 210 and appear as if the service provider sent the message, when in fact, the inventive system 200 creates and sends the message to the consumer.

Referring now to FIG. 11J, this figure is another exemplary computer screen display illustrating a customer service representative user interface according to an exemplary embodiment of the invention. This display screen can provide a message 644B being presented to a CSR to indicate that the service provider selected by the consumer is unable to complete the consumer service request.

Referring now to FIG. 11K, this figure is another exemplary computer screen display illustrating a customer service representative user interface according to an exemplary embodiment of the invention. This screen display illustrates a first set of exemplary questions 652B that a CSR can ask a consumer who desires to initiate a secondary market match process after a selected home service provider was found by the system 200 to be unable to service the consumer's service request.

Referring now to FIG. 11L, this figure is another exemplary computer screen display illustrating a customer service representative user interface according to an exemplary embodiment of the invention. This screen display illustrates a second set of exemplary questions 652C that a CSR can ask a consumer who desires to initiate a secondary market match process after a selected home service provider was found by the system 200 to be unable to service the consumer's service request.

Referring now to FIG. 11M, this figure is another exemplary computer screen display illustrating a customer service representative user interface according to an exemplary embodiment of the invention. This screen display illustrates a completed service request in which a CSR can verify the displayed service request information and then submit the request by selecting a submit button 652D.

Referring now to FIG. 12A, this figure is another exemplary computer screen display illustrating an on-line service request form according to an exemplary embodiment of the invention. This form can display categories 705B that can be selected by the consumer to help identify the type of consumer service request desired by the consumer.

Referring now to FIG. 12B, this figure is another exemplary computer screen display illustrating an on-line service request form according to an exemplary embodiment of the invention. This form can display geographic and timing categories 705C that can be selected by the consumer to help identify the location and timing for the consumer home service request.

Referring now to FIG. 12C, this figure is another exemplary computer screen display illustrating an on-line service request form according to an exemplary embodiment of the invention. This form can display project specific categories 705D, such as for roofing consumer service requests, that can be selected by the consumer to help identify more specifics about the type of work desired by the consumer.

Referring now to FIG. 12D, this figure is another exemplary computer screen display illustrating an on-line service request form according to an exemplary embodiment of the invention. This form can display contact information entry fields 725B for the consumer to enter. This form can also display a consumer service request button 730B that can be selected by the consumer after all required contact information is entered by the consumer into the contact information entry fields 725B.

Referring now to FIG. 12E, this figure is another exemplary computer screen display illustrating a service request submission confirmation according to an exemplary embodiment of the invention. This display can include a “next steps” message 730 advising the consumer of the next steps in the process after the consumer has submitted the consumer service request.

Referring now to FIG. 12F, this figure is another exemplary computer screen display illustrating a e-mail notification of an exact match lead request sent to a home service provider according to an exemplary embodiment of the invention. This e-mail notification of an exact match lead request can contain consumer contact information 735B so that the service provider can immediately contact the consumer.

Referring now to FIG. 12G, this figure is another exemplary computer screen display illustrating a e-mail notification of an exact match confirmation of the submission of a consumer's service request that is sent to a consumer according to an exemplary embodiment of the invention. This e-mail notification sent to a consumer explains that the exact match service request was submitted to the exact matched, consumer-selected service provider. The e-mail can also include a consumer expectations message 740B.

Referring now to FIG. 12H, this figure is another exemplary computer screen display illustrating a e-mail notification of an exact match lead request sent to a consumer according to an exemplary embodiment of the invention. This e-mail notification can be sent to a consumer regarding an exact match with a service provider can provide a consumer with a message 745B that appears to originate from the service provider, when in fact, the matching system 200 creates and sends the message on behalf of the service provider.

Referring now to FIG. 121, this figure is another exemplary computer screen display illustrating an on-line service request form according to an exemplary embodiment of the invention. This form can display an unable to service message 750B when a consumer selects a home service provider who does not match the consumer's service request.

Referring now to FIG. 13A, this figure is another exemplary computer screen display illustrating an e-mail notification of a market match request sent to a consumer according to an exemplary embodiment of the invention. This e-mail notification informs the consumer that the consumer's service request has been submitted to the market match secondary process. The notification can also contain an expectations message 810B that informs the consumer what he or she can expect at this stage in the market match process.

Referring now to FIG. 13B, this figure is another exemplary computer screen display illustrating an e-mail notification of a market match sent to a home service provider according to an exemplary embodiment of the invention. This e-mail notification informs a service provider that the provider has matched a consumer service request and provides the service provider with contact information 815B for the consumer.

Referring now to FIG. 13C, this figure is another exemplary computer screen display illustrating an e-mail notification of a service provider profile match from a market match that is sent to a consumer according to an exemplary embodiment of the invention. This e-mail notification can include a message 830B that has a complete service provider profile 210 so that the consumer can make a decision on whether to contact the service provider or not.

Referring now to FIG. 13D, this figure is another exemplary computer screen display illustrating a web page listing a service provider profile match from a market match that can be viewed by a consumer according to an exemplary embodiment of the invention. This web page can include a complete service provider profile 210 and decision tools 835 such as the appropriate questions to ask the market matched service provider so that the consumer can make a decision on whether to contact and/or hire the service provider or not.

Referring now to FIG. 13E, this figure is another exemplary computer screen display illustrating a web page listing a service provider profile match from an exact match primary process that can be viewed by a consumer according to an exemplary embodiment of the invention. This web page can be displayed when a consumer accesses their account 840B with the system 200 and can display complete service provider profiles 210 of all service providers who have been identified as an exact match for the consumer for one or more home service projects.

Referring now to FIG. 13F, this figure is another exemplary computer screen display illustrating a web page listing a service provider profile match from a market match secondary process that can be viewed by a consumer according to an exemplary embodiment of the invention. This web page can include rating and review information 845B that can assist a consumer to decide whether to contact a service provider or not.

Referring now to FIG. 13G, this figure is another exemplary computer screen display illustrating an e-mail message that can be created from a communications platform by a consumer according to an exemplary embodiment of the invention. This e-mail message can be created by an option displayed on a web page that lists profiles of market matched service providers. The consumer can type-in appropriate message information in a message field 850 of the e-mail message.

Referring now to FIG. 13H, this figure is another exemplary computer screen display illustrating an e-mail notification of a market matched service providers sent to a consumer according to an exemplary embodiment of the invention. This e-mail notification is sent after a predetermined period of time or after a maximum number of service providers have accepted the consumer service request. The message can provide a listing 855B of home service providers who accepted a consumer's home service request.

Referring now to FIG. 13I, this figure is another exemplary computer screen display illustrating an e-mail notification of a request for ratings and reviews of service providers sent to a consumer according to an exemplary embodiment of the invention. This request is commonly made by distributing an e-mail communication created by the matching system 200 and is designed to identify which service provider was selected by a consumer from the market match process to fulfill the consumer's need. The e-mail message can include a rating scale 860B.

Referring now to FIG. 13J, this figure is another exemplary computer screen display illustrating a web page listing service providers who are not in the matching system database that can be viewed by a consumer according to an exemplary embodiment of the invention. This web page can include a listing or directory of professionals 870B who are not part of database 203 of the inventive matching system 200.

Referring now to FIG. 13K, this figure is another exemplary computer screen display illustrating an e-mail notification of service providers who are not in the database of the matching system according to an exemplary embodiment of the invention. This e-mail message may contain links 875B that can be used to connect to service professionals who are not members of the database 203 of the inventive matching system 203.

Referring now to FIG. 13L, this figure is another exemplary computer screen display illustrating an e-mail notification that no market match service providers have responded to the market match request according to an exemplary embodiment of the invention. This e-mail message may be sent to the consumer and it may contain a non-market match message 880B as well as new consumer request data entry fields.

Referring now to FIG. 13M, this figure is another exemplary computer screen display illustrating a web page listing service providers who were market matched to the consumer service request but did not accept the request according to an exemplary embodiment of the invention. This web page can include a listing 885B of service providers who matched the consumer service request as a result of the market match secondary process but who failed to accept the request.

Referring now to FIG. 13N, this figure is another exemplary computer screen display illustrating an e-mail notification that can be sent to Lead Select enrolled service providers according to an exemplary embodiment of the invention. This e-mail notification can include the consumer's description of his or her service need, in addition to a web link 900 that a service provider can click to indicate their intent to accept the lead.

In summary, the invention provides a system that enables a consumer to select an appropriate service provider, to determine if the consumer's needs can be met by the pre-qualified service provider that was selected by the consumer, and to connect the two parties together if it is determined that the home service provider can fulfill the service needs of the consumer. However, if it has been determined that the service provider selected by the consumer is unable to meet the consumer's need(s), the system can facilitate a match to other pre-qualified service providers not initially selected or unknown to the consumer who may meet the consumer's service need(s).

It should be understood that the foregoing relates only to illustrate the embodiments of the present invention, and that numerous changes may be made therein without departing from the scope and spirit of the invention as defined by the following claims.

What is claimed is:

1. A method for matching a consumer to a home service provider comprising:
receiving home service provider information from a home service provider, the home service provider information comprising at least one of a home service provider geographic location, work preferences of the home service provider, and spending limit for receiving one or more consumer leads;
storing the home service provider information in a computer database;
receiving a consumer request for a home service with a computer, the consumer request comprising at least one of a home service geographic location and a type of the home service;
receiving a selection of a single home service provider with a computer;
determining with the computer if home service provider geographic location of the selected single home service provider matches the home service geographic location;
determining with the computer if work preferences of the selected single home service provider match the type of service of the consumer request;
determining with the computer if a spending limit for receiving one or more consumer leads of the selected single home service provider has met a predetermined threshold; and
providing access to the selected home service provider if the selected home service provider matches the home service location and the type of service of the consumer request, and falls within the predetermined threshold for the spending limit.

2. The method of claim 1, wherein receiving home service provider information from a home service provider further comprises receiving licensing information from the home service provider.

3. The method of claim 2, further comprising determining with the computer if licensing information of a selected home service provider is valid.

4. The method of claim 1, wherein receiving home service provider information from a home service provider further comprises receiving a home service provider payment method for receiving one or more consumer requests.

5. The method of claim 4, further comprising determining with the computer if a home service provider payment method for receiving one or more consumer leads of a selected home service provider is valid.

6. The method of claim 1, further determining with the computer if a selected home service provider desires to accept consumer leads after querying the database with the computer.

7. The method of claim 1, wherein determining with the computer if a home service provider geographic location of a selected single home service provider matches the home service geographic location further comprises a comparing a first zip code of the selected single home service provider with a second zip code of the home service geographic location.

8. The method of claim 1, further comprising receiving the home service geographic location with an interactive voice recognition system.

9. The method of claim 1, wherein receiving a consumer request for a home service with the computer further comprises receiving the consumer request over a computer network.

10. The method of claim 1, further comprising receiving preferences for communication from at least one of a consumer and a selected single home service provider.

11. A method for matching a consumer to a home service provider comprising:
receiving home service provider information from a home service provider, the home service provider information comprising at least one of a home service provider geographic location, work preferences of the home service provider, a home service provider payment method for receiving one or more consumer requests;
storing the home service provider information in a computer database;
receiving a consumer request for a home service with a computer, the consumer request comprising at least one of a home service geographic location and a type of the home service;
receiving a selection of a single home service provider with a computer;
determining with the computer if a home service provider geographic location of the selected single home service provide matches the home service geographic location;
determining with the computer if work preferences of the selected single home service provider match the type of service of the consumer request;
determining with the computer if a home service provider payment method for receiving one or more consumer leads of the selected single home service provider is valid ; and
providing access to the selected home service provider if the selected home service provider matches the home service location and the type of service of the consumer request, and if the home service provider payment method of the selected home service provider is valid.

12. The method of claim 11, wherein receiving home service provider information from a home service provider further comprises receiving a spending limit for receiving one or more consumer leads from a home service provider.

13. The method of claim 12, further comprising determining with the computer if spending limit for receiving one or more consumer leads for a selected single service provider has met a predetermined threshold.

14. The method of claim 11, wherein receiving home service provider information from a home service provider further comprises receiving licensing information from the home service provider.

15. The method of claim 14, further comprising determining with the computer if licensing information of the selected single home service provider is valid.

16. The method of claim 11, further comprises determining with the computer if a home service provider desires to accept consumer leads.

17. The method of claim 11, wherein determining with the computer if a home service provider geographic location of a selected single home service provider matches the home service geographic location comprises comparing a first zip code of the selected single home service provider with a second zip code of the home service geographic location.
